(19) United States
(12) Patent Application Publication
(10) Pub. No.: US 2025/0391313 A1
(43) Pub. Date: Dec. 25, 2025

(54) CIRCUIT OF COMPENSATING FOR OFFSET, CIRCUIT OF DRIVING DISPLAY AND OPERATION METHOD THEREOF

(71) Applicant: SAMSUNG ELECTRONICS CO., LTD., Suwon-si (KR)

(72) Inventors: Yunseok JANG, Suwon-si (KR); Daehyun MOON, Suwon-si (KR); Jihoon KIM, Suwon-si (KR); Young-Bae MOON, Suwon-si (KR); Keunhwa PARK, Suwon-si (KR); Seung Uk BAEK, Suwon-si (KR); Kyung-Hoon CHUNG, Suwon-si (KR)

(73) Assignee: SAMSUNG ELECTRONICS CO., LTD., Suwon-si (KR)

(21) Appl. No.: 19/095,497

(22) Filed: Mar. 31, 2025

(30) Foreign Application Priority Data
Jun. 21, 2024 (KR) 10-2024-0081352

(51) Int. Cl. G09G 3/20

(52) U.S. Cl. CPC G09G 3/2092; G09G 2310/0267; G09G 2310/0275; G09G 2320/0247; G09G 2330/028

(57) ABSTRACT

Provided is an offset compensating circuit that includes: an input stage circuit with first and second input circuits, a first multiplexer configured to activate one of the first second input circuits, a second multiplexer configured to change a polarity of an offset, and an offset trimming circuit configured to compensate the offset; an amplification stage circuit with a first current mirror, a second current mirror and a third multiplexer configured to change the polarity of the offset; an output stage circuit configured to receive voltages generated from the first current mirror and the second current mirror; and a switch configured to control a path connected to the output stage circuit or the input stage circuit.

### CROSS-REFERENCE TO RELATED APPLICATION

This application claims priority to Korean Patent Application No. 10-2024-0081352, filed on Jun. 21, 2024, in the Korean Intellectual Property Office, the disclosure of which is incorporated herein by reference in its entirety.

### BACKGROUND

### 1. Field

The present disclosure relates to an offset voltage compensation circuit, a display driving circuit including the offset voltage compensation circuit, and a method of operating the display driving circuit.

### 2. Description of Related Art

A gamma amplifier generates a gamma voltage (or a gamma reference voltage) and outputs the gamma voltage to a source driver. When the same input voltage is applied to each input terminal, an ideal gamma amplifier outputs a voltage of 0 V. However, due to design issues or process issues in a semiconductor circuit, a typical gamma amplifier outputs a non-zero voltage even if the same amount of input voltage is applied to each input terminal. This may be referred to as an offset.

Typically, an offset voltage is applied to the input terminal to make the output voltage 0 V (to remove the offset). It is important to efficiently compensate for the offset of the amplifier, and accordingly, circuits and methods for compensating the offset are continuously being developed. To compensate for the offset of the gamma amplifier, either a chopping method or auto-zero method may be used. In the case of the chopping method, there is a problem that a flicker phenomenon occurs on the display. In the case of the auto-zero method, there is the problem that the size is relatively large, and the current consumption is large.

### SUMMARY

One or more example embodiments provide an offset compensating circuit that compensates for an offset of a gamma amplifier using a trimming method.

One or more example embodiments also provide an offset compensating circuit with good offset compensation performance and with relatively small area (size) and current consumption.

The technical tasks to be achieved by the present example embodiments are not limited to the technical tasks described above, and other technical tasks may be inferred from the following example embodiments.

According to an aspect of an example embodiment, an offset compensating circuit includes: an input stage circuit including a first input circuit, a second input circuit, a first multiplexer configured to activate one of the first input circuit and the second input circuit, a second multiplexer configured to change a polarity of an offset of a gamma voltage generation circuit, and an offset trimming circuit configured to compensate the offset; an amplification stage circuit including a first current mirror, a second current mirror and a third multiplexer configured to change the polarity of the offset; an output stage circuit configured to receive voltages generated from the first current mirror and the second current mirror; and a switch configured to control a path connected to the output stage circuit or the input stage circuit.

According to another aspect of an example embodiment, a display driving circuit including: a driving controller; a gamma voltage generation circuit that is configured to receive an input voltage that is output from the driving controller and output a gamma voltage, wherein the gamma voltage generation circuit includes an offset compensating circuit; a source driver configured to receive the gamma voltage and output a data signal; and a gate driver configured to output a gate signal. The offset compensating circuit includes: an input stage circuit including a first input circuit, a second input circuit, a first multiplexer configured to activate one of the first input circuit and the second input circuit, a second multiplexer configured to change a polarity of an offset of the gamma voltage generation circuit, and an offset trimming circuit configured to compensate the offset; an amplification stage circuit including a first current mirror, a second current mirror and a third multiplexer configured to change the polarity of the offset; an output stage circuit configured to receive voltages generated from the first current mirror and the second current mirror; and a switch configured to control a path connected to the output stage circuit or the input stage circuit.

According to another aspect of an example embodiment, a method of operating a display driving circuit including a driving controller, a gamma voltage generation circuit including an offset compensating circuit, a source driver and a gate driver, is provided. The method includes: activating one of a first input circuit and a second input circuit included in the offset compensating circuit by controlling a first multiplexer included in the offset compensating circuit; identifying a polarity of an offset of the offset compensating circuit; controlling a second multiplexer and a third multiplexer included in the offset compensating circuit to control the polarity of the offset to be a predetermined first polarity; identifying whether the polarity of the offset changes as the offset is compensated while a plurality of transistors included in an offset trimming circuit of the offset compensating circuit are activated in an order of greatest compensation voltage; and generating a trimming code corresponding to a result of identifying whether the polarity of the offset changes for each of the plurality of transistors.

Additional aspects of example embodiments will be set forth in part in the description which follows and, in part, will be apparent from the description, or may be learned by practice of the disclosure.

According to one or more example embodiments, it is possible to provide an offset compensating circuit that compensates for an offset of a gamma amplifier using a trimming method.

According to one or more example embodiments, it is possible to provide an offset compensating circuit with good performance but with relatively small area (size) and current consumption.

According to one or more example embodiments, it is possible to provide a gamma voltage generation circuit including an offset compensating circuit and a display driving circuit.

The effects to be obtained in the present disclosure are not limited to the aforementioned effects, and other effects not mentioned herein will be clearly understood by those skilled in the art from the following description.

### BRIEF DESCRIPTION OF DRAWINGS

These and/or other aspects, features, and advantages will be more apparent from the following description of example embodiments, taken in conjunction with the accompanying drawings, in which:

FIG. 1 is a block diagram illustrating an offset compensating circuit according to an example embodiment;

FIG. 2 is a circuit diagram of an offset compensating circuit according to an example embodiment;

FIG. 3A is a circuit diagram illustrating a portion of an input stage of an offset compensating circuit according to an example embodiment;

FIG. 3B is a circuit diagram of an offset trimming circuit according to an example embodiment;

FIG. 4 is a circuit diagram of an amplification stage of an offset compensating circuit according to an example embodiment;

FIGS. 5A, 5B and 5C are diagrams for explaining operations of an offset compensating circuit including a gamma amplifier according to an example embodiment;

FIG. 6 is a flowchart of operations of a driving controller according to an example embodiment;

FIG. 7 is a flowchart of operations of a driving controller according to an example embodiment;

FIG. 8 is a timing diagram illustrating an operation of a gamma amplifier according to an example embodiment;

FIG. 9 is a diagram illustrating an internal input mode of a gamma amplifier corresponding to a range of input voltages according to an example embodiment;

FIG. 10 is a flowchart of operations of a driving controller according to an example embodiment;

FIG. 11 is a block diagram illustrating a display apparatus according to an example embodiment;

FIG. 12 is a flowchart of operations of a display driving circuit according to an example embodiment; and

FIGS. 13A, 13B and 13C illustrate graphs showing the size of an offset according to an input voltage when using an offset compensating circuit according to an example embodiment.

### DETAILED DESCRIPTION

Terms used in the example embodiments are selected from currently widely used general terms when possible while considering the functions in the present disclosure. However, the terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms.

Throughout the specification, when a part is described as “comprising or including” a component, it does not exclude another component but may further include another component unless otherwise stated. Furthermore, terms such as “ . . . unit,” “ . . . group,” and “ . . . module” described in the specification mean a unit that processes at least one function or operation, which may be implemented as hardware, software, or a combination thereof.

Hereinafter, example embodiments of the present disclosure will be described in detail with reference to the accompanying drawings so that those of ordinary skill in the art to which the present disclosure pertains may easily implement them. However, the present disclosure may be implemented in multiple different forms and is not limited to the example embodiments described herein.

Hereinafter, example embodiments will be described in detail with reference to the drawings.

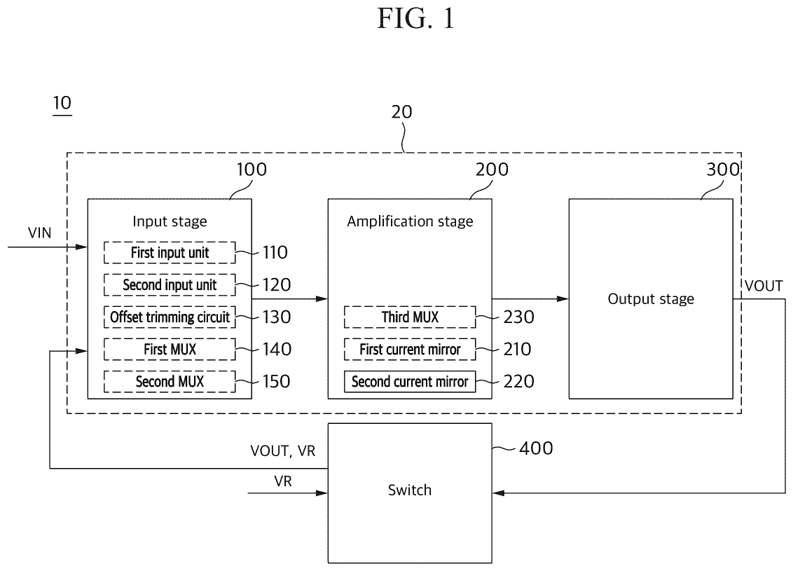

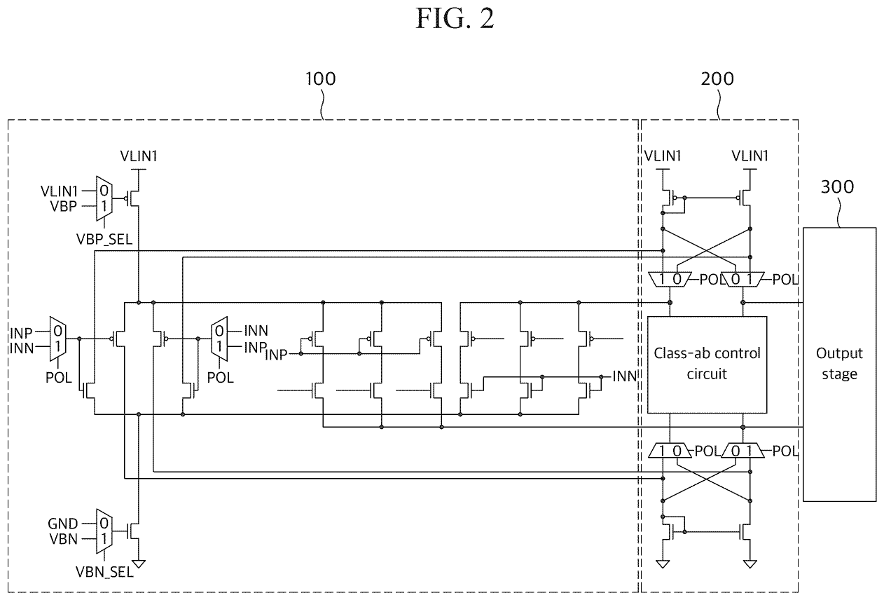

FIG. 1 is a block diagram illustrating an offset compensating circuit 10 according to an example embodiment. FIG. 2 is a circuit diagram of the offset compensating circuit 10 according to an example embodiment.

The offset compensating circuit 10 may include a gamma amplifier 20 and a switch 400. In this regard, an input stage (i.e., an input stage circuit) 100, an amplification stage (i.e., an amplification stage circuit) 200, and an output stage (i.e., an output stage circuit) 300 of the offset compensating circuit 10 may correspond to one gamma amplifier 20. In the present disclosure, the term “gamma amplifier 20” may indicate an element of the offset compensating circuit 10 excluding the switch 400. The switch 400 may indicate an element that controls a path connected to the output stage 300 or the input stage 100 under the control of a driving controller. The offset compensating circuit 10 may compensate for the offset of the gamma amplifier 20. The gamma amplifier 20 may be an operational amplifier that generates a gamma voltage (or a gamma reference voltage) and provides the gamma voltage to a source driver. In a case of an ideal gamma amplifier of 20, the difference between the input voltages that are input to the input stage 100 (for example, (+) terminal and (−) terminal) is equal to the output voltage that is output from the output stage 300. In this regard, in the case of the ideal gamma amplifier of 20, if the input voltages that are input to the input stage 100 are the same, the output voltage from the output stage 300 is 0 V. However, due to design issues or process issues in the semiconductor circuit, the gamma amplifier 20 outputs a non-zero voltage even if the same amount of input voltage is applied to each input terminal, and this may be referred to as an offset. In the present disclosure, as described above, the term “offset” refers to the difference between the ideal output voltage (the target output voltage) of the gamma amplifier 20 and the actual output voltage. The unit of offset may be expressed as V, which is the unit of voltage. The reason for the offset in the gamma amplifier 20 could be a mismatch between the transistors.

In the case of the ideal gamma amplifier 20, the operable voltage range may be from a ground voltage GND (a base voltage) to a power voltage or an operating voltage VDD. However, for the gamma amplifier 20 consisting of only n-channel metal-oxide semiconductor (NMOS) transistors or the gamma amplifier 20 consisting of only p-channel metal-oxide semiconductor (PMOS) transistors, the operable voltage range may be narrower than the voltage range described above. For the gamma amplifier 20 consisting of a CMOS circuit using both the NMOS transistor and the PMOS transistor, the voltage range may be from the GND to the VDD. This gamma amplifier 20 may be may be referred to as a Rail-to-Rail gamma amplifier 20. For the Rail to Rail gamma amplifier 20, if a relatively high input voltage is used (if the brightness of the display panel is set low), the NMOS transistor is mainly used, and if a relatively low input voltage is used (i.e., the brightness of the display panel is set high), the PMOS transistor is mainly used. If an intermediate input voltage is used, the NMOS transistor and the PMOS transistor are used simultaneously.

In general, offset occurs significantly at relatively low or high input voltages. In this regard, a large offset occurs if the NMOS transistor is mainly used or if the PMOS transistor is mainly used. Therefore, it is important to compensate for the offset over the range of input voltages described above (i.e., the low input voltage range and the high input voltage range).

Referring to FIGS. 1 and 2, the offset compensating circuit 10 may include the input stage 100, the amplification stage 200, the output stage 300, and the switch 400. According to an example embodiment, the input stage 100 may include a first input circuit 110, a second input circuit 120, an offset trimming circuit 130, a first multiplexer (MUX) 140 and a second MUX 150. The input stage 100 may receive an input signal VIN or an output signal VOUT. Further, the input stage 100 may receive a reference voltage VR that is output from a voltage selector. The input signal VIN is a signal that is input from the driving controller, and the input signal VIN corresponding to the brightness of the display set by the user input may be input to the input stage 100 of the offset compensating circuit 10.

The signals input to each of the first input circuit 110 and the second input circuit 120 may be identical and may be different. Each of the first input circuit 110 and the second input circuit 120 may generate a current corresponding to an input signal and supply the generated current to the amplification stage 200. According to an example embodiment, with respect to the current generated from the first input circuit 110 and the second input circuit 120, the offset may be compensated through the offset trimming circuit 130. A detailed example embodiments of offset compensation will be provided later.

According to an example embodiment, the amplification stage 200 may include a first current mirror 210, a second current mirror 220 and a third MUX 230. The amplification stage 200 may receive currents generated from the input stage 100. The amplification stage 200 may generate a voltage based on the current that the amplification stage 200 receives, and supply the generated voltage to the output stage 300. The first current mirror 210 may receive the current generated from the first input circuit 110, and the second current mirror 220 may receive the current generated from the second input circuit 120. The third MUX 230 may change the polarity of the offset.

According to an example embodiment, the offset compensating circuit 10 may be implemented with a complementary metal-oxide-semiconductor (CMOS) circuit. The first input circuit 110 may be implemented with a PMOS circuit including multiple PMOS transistors. The second input circuit 120 may be implemented with an NMOS circuit including multiple NMOS transistors. The first current mirror 210 may be implemented with a NMOS circuit, and the second current mirror 220 may be implemented with a PMOS circuit. In this regard, if the offset compensating circuit 10 is implemented with a CMOS circuit, the first input circuit 110 implemented with a PMOS circuit may be connected to the first current mirror 210 implemented with an NMOS circuit in the amplification stage 200. Further, the second input circuit 120 implemented with an NMOS circuit in the input stage 100 may be connected to the second current mirror 220 implemented with a PMOS circuit in the amplification stage 200.

According to an example embodiment, the first MUX 140 may activate either the first input circuit 110 or the second input circuit 120. The first MUX 140 may be configured to select and output only one of multiple input signals based on a selection input signal. The first MUX 140 is connected to the first input circuit 110 and the second input circuit 120 and may output a signal that activates only one of the first input circuit 110 and the second input circuit 120. There may be a plurality of first MUXs 140 included in the offset compensating circuit 10. The specific configuration and operation of the first MUX 140 will be described later.

According to an example embodiment, the second MUX 150 may be configured to change the polarity of the offset. For example, the offset may have positive (+) polarity, and may have negative (−) polarity. The second MUX 150 may be configured to select and output only one of multiple input signals based on a selection input signal. The second MUX 150 may change the polarity of the offset of the gamma amplifier 20. For example, the second MUX 150 may change the polarity of the offset from (−) to (+) based on the signal received from the driving controller. There may be a plurality of second MUXs 150 included in the offset compensating circuit 10. The specific configuration and operation of the second MUX 150 will be described later.

According to an example embodiment, the output stage 300 may receive the voltage (or current) generated by the amplification stage 200. The output stage 300 may generate a voltage based on the received voltage (or current), and output the generated voltage to the outside of the offset compensating circuit 10. The output stage 300 may receive voltages generated from the first current mirror 210 and the second current mirror 220, and output an output voltage.

According to an example embodiment, the switch 400 may be configured to control a path connected to the output stage 300 or the input stage 100. The switch 400 may receive the output signal VOUT that is output from the output stage 300. The switch 400 may receive the reference voltage VR that is output from the voltage selector. The switch 400 may also receive the input signal VIN that is output from the driving controller. The switch 400 may include a plurality of switches. Under the control of the driving controller, the switch 400 may control the path between the driving controller and the input stage 100, the path between two terminals of the input stage 100, the path between the voltage selector and the input stage 100, and the path between the output stage 300 and the input stage 100. Depending on the operation of the switch 400, the gamma amplifier 20 may also operate as a comparator, or as a buffer.

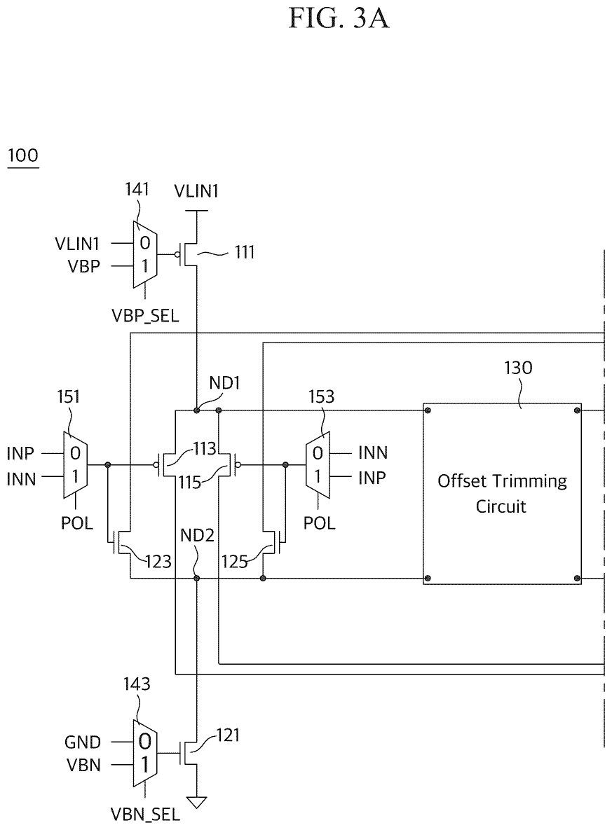

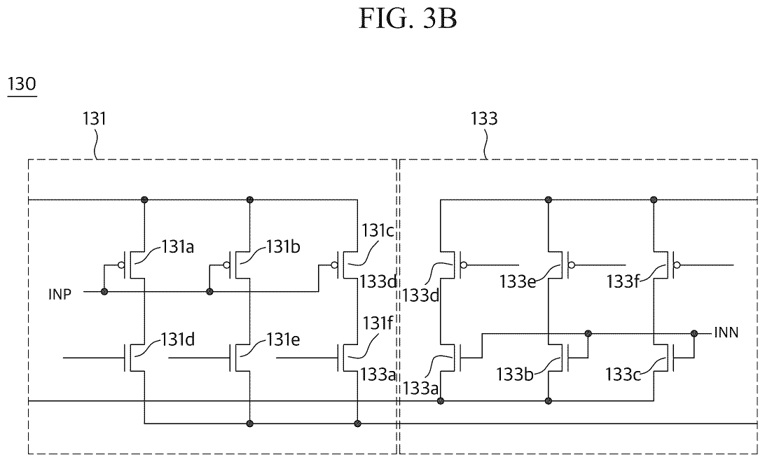

FIG. 3A is a circuit diagram illustrating the input stage 100 of the offset compensating circuit 10 according to an example embodiment. Specifically, FIG. 3A is a circuit diagram illustrating the connection relationship of the first input circuit 110, the second input circuit 120, the first MUX 140 and the second MUX 150 of the input stage 100 illustrated in FIG. 1.

Referring to FIGS. 1 and 3A, the input stage 100 of the offset compensating circuit 10 may include the first input circuit 110, the second input circuit 120, the first MUX 140, the second MUX 150, and the offset trimming circuit 130. The offset compensating circuit 10 may be implemented in a CMOS circuit.

According to an example embodiment, the first input circuit 110 may include a plurality of PMOS transistors. The first input circuit 110 may include a first PMOS transistor 111, a second PMOS transistor 113 and a third PMOS transistor 115. According to an example embodiment, the second input circuit 120 may include a plurality of NMOS transistors. The second input circuit 120 may include a first NMOS transistor 121, a second NMOS transistor 123 and a third NMOS transistor 125.

According to an example embodiment, the first MUX 140 may include a plurality of MUXs. Specifically, the first MUX 140 may include a first sub MUX 141 and a second sub MUX 143. According to an example embodiment, the second MUX 150 may include a plurality of MUXs. Specifically, the second MUX 150 may include a third sub MUX 151 and a fourth sub MUX 153.

According to an example embodiment, the first sub MUX 141 included in the first MUX 140 may be connected to the gate terminal of the first PMOS transistor 111, which is connected to a power voltage VLIN1 among the plurality of PMOS transistors (the first PMOS transistor 111, the second PMOS transistor 113 and the third PMOS transistor 115). The power voltage VLIN1 may be the driving voltage to drive the offset compensating circuit 10. The first sub MUX 141 may select and output either the power voltage VLIN1 or a PMOS bias voltage VBP based on a selection input signal VBP_SEL.

If the logic level of the selection input signal VBP_SEL is high (H) (i.e., 1), the first sub MUX 141 may output the PMOS bias voltage VBP. The power voltage VLIN1 that is output from the first sub MUX 141 is input to the gate terminal of the first PMOS transistor 111, and in this case, the bias voltage is applied to the first PMOS transistor 111, so that the first PMOS transistor 111 may operate as a current source. The voltage of a first node ND1 may be determined by the input signal pair (a first input voltage INN and a second input voltage INP) applied to the second MUX 150. Because the first PMOS transistor 111 acts as a current source, current may also flow through the second PMOS transistor 113 and the third PMOS transistor 115. Therefore, the second PMOS transistor 113 and the third PMOS transistor 115 may be activated (ON).

If the logic level of the selection input signal VBP_SEL is low (L) (i.e., 0), the first sub MUX 141 may output the power voltage VLIN1. The power voltage VLIN1 that is output from the first sub MUX 141 may be input to the gate terminal of the first PMOS transistor 111, and the first PMOS transistor 111 may be deactivated (OFF), and no current may flow. If the first PMOS transistor 111 is deactivated, current may not flow through the second PMOS transistor 113 and the third PMOS transistor 115. Therefore, the second PMOS transistor 113 and the third PMOS transistor 115 may be deactivated (OFF).

In this regard, based on the selection input signal VBP_SEL from the driving controller, the first sub MUX 141 may activate or deactivate the first input circuit 110, which includes the plurality of PMOS transistors.

According to an example embodiment, the second sub MUX 143 included in the first MUX 140 may be connected to the gate terminal of the first NMOS transistor 121, which is connected to the ground voltage GND among the plurality of NMOS transistors. The second sub MUX 143 may select and output either the ground voltage GND or a NMOS bias voltage VBN based on a selection input signal VBN_SEL.

If the logic level of the selection input signal VBN_SEL is H (i.e., 1), the second sub MUX 143 may output the NMOS bias voltage VBN. The NMOS bias voltage VBN that is output from the second sub MUX 143 is input to the gate terminal of the first NMOS transistor 121, and in this case, the bias voltage is applied to the first NMOS transistor 121, and the first NMOS transistor 121 may operate as a current source. The voltage of a second node ND2 may be determined by the input signal pair (the first input voltage INN and the second input voltage INP) applied to the second MUX 150. Because the first NMOS transistor 121 acts as a current source, current may also flow through the second NMOS transistor 123 and the third NMOS transistor 125. Therefore, the second NMOS transistor 123 and the third NMOS transistor 125 may be activated (ON).

If the selected input signal VBN_SEL is a logic level L, the second sub MUX 143 may output the ground voltage GND. The ground voltage GND that is output from the second sub MUX 143 may be input to the gate terminal of the second NMOS transistor 121, and the second NMOS transistor 121 may be turned off and no current may flow. Because the second NMOS transistor 121 is deactivated, no current may flow through the second NMOS transistor 123 and the third NMOS transistor 125. Therefore, the second NMOS transistor 123 and the third NMOS transistor 125 may be deactivated (OFF).

In this regard, based on the selection input signal VBN_SEL that is input from the driving controller, the second sub MUX 143 may activate or deactivate the second input circuit 120, which contains plurality of NMOS transistors (the first NMOS transistor 121, the second NMOS transistor 123 and the third NMOS transistor 125).

Using the above-described method, the gamma amplifier 20 included in the offset compensating circuit 10 may be operated in either the PMOS mode or the NMOS mode. In the present disclosure, the PMOS mode refers to the internal input mode of the gamma amplifier 20 in which only the PMOS transistors inside the gamma amplifier 20 are activated, and the NMOS mode refers to the internal input mode of the gamma amplifier 20 in which only the NMOS transistors inside the gamma amplifier 20 are activated. In this regard, the PMOS mode and the NMOS mode are internal input modes that operate by activating only some of the internal components included in the gamma amplifier 20. The PMOS mode and the NMOS mode are not operating modes determined externally of the gamma amplifier 20.

In order to operate the gamma amplifier 20 in the PMOS mode, the driving controller may set the selection input signal VBP_SEL, which is input to the first sub MUX 141, to H, and set the selection input signal VBN_SEL, which is input to the second sub MUX 143, to L. In this case, the plurality of PMOS transistors (the first PMOS transistor 111, the second PMOS transistor 113 and the third PMOS transistor 115) included in the first input circuit 110 are activated (ON), and the plurality of NMOS transistors (the first NMOS transistor 121, the second NMOS transistor 123 and the third NMOS transistor 125) included in the second input circuit 120 are deactivated (OFF), and thus the gamma amplifier 20 may operate in the PMOS mode.

In order to operate the gamma amplifier 20 in the NMOS mode, the driving controller may set the selection input signal VBP_SEL, which is input to the first sub MUX 141, to L, and set the selection input signal VBN_SEL, which is input to the second sub MUX 143, to H. In this case, the plurality of PMOS transistors (the first PMOS transistor 111, the second PMOS transistor 113 and the third PMOS transistor 115) included in the first input circuit 110 are deactivated (OFF), and the plurality of NMOS transistors (the first NMOS transistor 121, the second NMOS transistor 123 and the third NMOS transistor 125) included in the second input circuit 120 are activated (ON), and thus the gamma amplifier 20 may operate in the NMOS mode.

According to an example embodiment, the second MUX 150, which is configured to change the polarity of the offset, may include multiple MUXs. For example, the second MUX 150 may include the third sub MUX 151 and the fourth sub MUX 153.

According to an example embodiment, based on a selection input signal POL, the third sub MUX 151 and the fourth sub MUX 153 included in the second MUX 150 may output one of the input signal pairs (the first input voltage INN and the second input voltage INP). The input signal pair (the first input voltage INN and the second input voltage INP) may be a differential input signal and include the first input voltage INN and the second input voltage INP. A plurality of second MUXs 150 may be connected to the gate terminals of the remaining PMOS transistors (the second PMOS transistor 113 and the third PMOS transistor 115) except the first PMOS transistor 111 among the plurality of PMOS transistors (the first PMOS transistor 111, the second PMOS transistor 113 and the third PMOS transistor 115), and to the gate terminals of the remaining NMOS transistors (the second NMOS transistor 123 and the third NMOS transistor 125) except the first NMOS transistor 121 among the plurality of NMOS transistors (the first NMOS transistor 121, the second NMOS transistor 123 and the third NMOS transistor 125).

According to an example embodiment, the third sub MUX 151 may be connected to the gate terminal of the second PMOS transistor 113 and the gate terminal of the second NMOS transistor 123. If the logic level of the selection input signal POL is H (i.e., 1), the third sub MUX 151 may output the first input voltage INN to the gate terminal of the second PMOS transistor 113 and the gate terminal of the second NMOS transistor 123. If the logic level of the selection input signal POL is L (i.e., 0), the third sub MUX 151 may output the second input voltage INP to the gate terminal of the second PMOS transistor 113 and the gate terminal of the second NMOS transistor 123.

According to an example embodiment, the fourth sub MUX 153 may be connected to the gate terminal of the third PMOS transistor 115 and the gate terminal of the third NMOS transistor 125. If the logic level of the selection input signal POL is H (i.e., 1), the fourth sub MUX 153 may output the second input voltage INP to the gate terminal of the third PMOS transistor 115 and the gate terminal of the third NMOS transistor 125. If the logic level of the selection input signal POL is L (i.e., 0), the fourth sub MUX 153 may output the first input voltage INN to the gate terminal of the third PMOS transistor 115 and the gate terminal of the third NMOS transistor 125.

In this regard, the third sub MUX 151 and the fourth sub MUX 153 select and output different input signals among the input signal pair (the first input voltage INN and the second input voltage INP) according to the logic level of the selection input signal POL. Therefore, the second MUX 150, which includes the third sub MUX 151 and the fourth sub MUX 153, may change the polarity of the input stage 100 of the gamma amplifier 20, and accordingly, change the polarity of the offset of the gamma amplifier 20. For example, if the logic level of the selection input signal POL is L (i.e., 0), the polarity of the first input circuit 110 may be (+) and the polarity of the second input circuit 120 may be (−). In that case, if changing the logic level of the selection input signal POL to H (if changing to 1), the polarity of the first input circuit 110 may be changed to (−) and the polarity of the second input circuit 120 may be changed to (+). The polarity of the first input circuit 110 and the second input circuit 120 may indicate the voltage polarity of the input terminal when viewed from the outside of the gamma amplifier 20. Through this, if the logic level of the selection input signal POL is L (i.e., 0), the polarity of the offset of the gamma amplifier 20 is (−), if the logic level of the selection input signal POL is H (i.e., 1), the polarity of the offset of the gamma amplifier 20 may be changed to (+). In order to change the polarity of the offset, the selection input signal POL that is input to the second MUX 150 may be changed.

According to an example embodiment, the offset trimming circuit 130 may be configured to compensate for the offset of the gamma amplifier 20. The offset trimming circuit 130 may receive current generated from the first input circuit 110 or the second input circuit 120 and compensate for the offset by reducing the corresponding voltage. If the first input circuit 110 is activated, the offset trimming circuit 130 may receive the current that is output from the first input circuit 110, and if the second input circuit 120 is activated, the offset trimming circuit 130 may receive the current that is output from the second input circuit 120. The specific configuration of the offset trimming circuit 130 will be described later.

FIG. 3B is a circuit diagram of the offset trimming circuit 130 according to an example embodiment.

According to an example embodiment, the offset trimming circuit 130 may include a PMOS trimming circuit 131 and an NMOS trimming circuit 133. The first MUX 140 may activate either the PMOS trimming circuit 131 or the NMOS trimming circuit 133. In this regard, based on a selection input signal (the selection input signal VBP_SEL and the selection input signal VBN_SEL), the first MUX 140 may activate the first input circuit 110 and the PMOS trimming circuit 131 and activate the second input circuit 120 and the NMOS trimming circuit 133. In the present disclosure, the state in which the first input circuit 110 and the PMOS trimming circuit 131 are activated is referred to as the PMOS mode, and the state in which the second input circuit 120 and the NMOS trimming circuit 133 are activated is referred to as the NMOS mode.

According to an example embodiment, the PMOS trimming circuit 131 may include a plurality of pairs of PMOS transistors and switches that control whether the PMOS transistors are activated. The drawing illustrates that the number of pairs of PMOS transistors and switches included in the PMOS trimming circuit 131 is three. However, the present disclosure is not limited thereto. In order to increase the resolution for offset compensation, four or more pairs of PMOS transistors and switches may be included.

According to an example embodiment, for each of the plurality of PMOS transistors (a fourth PMOS transistor 131a, a fifth PMOS transistor 131b and a sixth PMOS transistor 131c) included in the PMOS trimming circuit 131, a different compensation voltage may be set to compensate for the offset. The PMOS trimming circuit 131 may include the fourth PMOS transistor 131a, the fifth PMOS transistor 131b, the sixth PMOS transistor 131c, a first switch 131d that controls whether the fourth PMOS transistor 131a is activated or not, a second switch 131e that controls whether the fifth PMOS transistor 131b is activated or not, and a third switch 131f that controls whether the sixth PMOS transistor 131c is activated or not. For each of the fourth PMOS transistor 131a, the fifth PMOS transistor 131b and the sixth PMOS transistor 131c, a different compensation voltage may be set. For example, the compensation voltage of 4 mV may be set for the fourth PMOS transistor 131a, the compensation voltage of 2 mV may be set for the fifth PMOS transistor 131b, and the compensation voltage of 1 mV may be set for the sixth PMOS transistor 131c. If the compensation voltage that is set for each of the plurality of PMOS transistors (the fourth PMOS transistor 131a, the fifth PMOS transistor 131b and the sixth PMOS transistor 131c) included in the PMOS trimming circuit 131 is reduced by ½, the binary search may be performed on the offset. A method for searching for a trimming code to compensate for the offset using the binary search method will be described later. Among the input signal pairs, the second input voltage INP may be input to the gate voltage terminal of each of the plurality of PMOS transistors (the fourth PMOS transistor 131a, the fifth PMOS transistor 131b and the sixth PMOS transistor 131c) included in the PMOS trimming circuit 131.

Each of the first switch 131d, the second switch 131e and the third switch 131f may control whether each of the fourth PMOS transistor 131a, the fifth PMOS transistor 131b and the sixth PMOS transistor 131c is activated. For example, under the control of the driving controller, the first switch 131d may block the current that is input to the source terminal of the fourth PMOS transistor 131a in order to deactivate the fourth PMOS transistor 131a. The first switch 131d, the second switch 131e and the third switch 131f may be implemented with NMOS transistors that perform the switch function.

According to an example embodiment, at least one predetermined PMOS transistor may be activated among the plurality of PMOS transistors (the fourth PMOS transistor 131a, the fifth PMOS transistor 131b and the sixth PMOS transistor 131c) included in the PMOS trimming circuit 131. According to an example embodiment, all of the plurality of PMOS transistors (the fourth PMOS transistor 131a, the fifth PMOS transistor 131b and the sixth PMOS transistor 131c) included in the PMOS trimming circuit 131 may be deactivated (for example, if there is no or very small offset). At least one predetermined PMOS transistor may be determined corresponding to the size of the offset of the gamma amplifier 20, and the order of at least one predetermined PMOS transistor among the plurality of PMOS transistors may be stored as a PMOS trimming code. The method of searching for PMOS trimming code will be described later.

According to an example embodiment, the NMOS trimming circuit 133 may include a plurality of pairs of NMOS transistors and switches that control whether the NMOS transistors are activated. The drawing illustrates that the number of pairs of NMOS transistors and switches included in the NMOS trimming circuit 133 is three. However, the present disclosure is not limited thereto, and four or more pairs of the NMOS transistors and switches may be included in order to increase the resolution for offset compensation.

According to an example embodiment, different compensation voltages may be set to compensate for the offset for each of a plurality of NMOS transistors (a fourth NMOS transistor 133a, a fifth NMOS transistor 133b and a sixth NMOS transistor 133c) included in the NMOS trimming circuit 133. The NMOS trimming circuit 133 may include the fourth NMOS transistor 133a, the fifth NMOS transistor 133b, the sixth NMOS transistor 133c, a fourth switch 133d that controls whether the fourth NMOS transistor 133a is activated, a fifth switch 133e that controls whether the fifth NMOS transistor 133b is activated, and a sixth switch 133f that controls whether the sixth NMOS transistor 133c is activated. Different compensation voltages may be set for each of the fourth NMOS transistor 133a, the fifth NMOS transistor 133b and the sixth NMOS transistor 133c. For example, the compensation voltage of 4 m V may be set for the fourth NMOS transistor 133a, the compensation voltage of 2 mV may be set for the fifth NMOS transistor 133b, and the compensation voltage of 1 mV may be set for the sixth NMOS transistor 133c. The binary search may be performed on the offset if the compensation voltage that is set for each of the plurality of NMOS transistors included in the NMOS trimming circuit 133 (the fourth NMOS transistor 133a, the fifth NMOS transistor 133b and the sixth NMOS transistor 133c) is reduced by ½. A method for searching for a trimming code to compensate for the offset using the binary search method will be described later. Among the input signal pairs, the first input voltage INN may be input to the gate voltage terminal of each of the plurality of NMOS transistors included in the NMOS trimming circuit 133 (the fourth NMOS transistor 133a, the fifth NMOS transistor 133b and the sixth NMOS transistor 133c).

Each of the fourth switch 133d, the fifth switch 133e and the sixth switch 133f may control whether each of the fourth NMOS transistor 133a, the fifth NMOS transistor 133b, and the sixth NMOS transistor 133c is activated. For example, the fourth switch 133d may deactivate the fourth NMOS transistor 133a by blocking the current that is input to the source terminal of the fourth NMOS transistor 133a under the control of the driving controller. The fourth switch 133d, the fifth switch 133e, and the sixth switch 133f may also be implemented with PMOS transistors that perform the switch function.

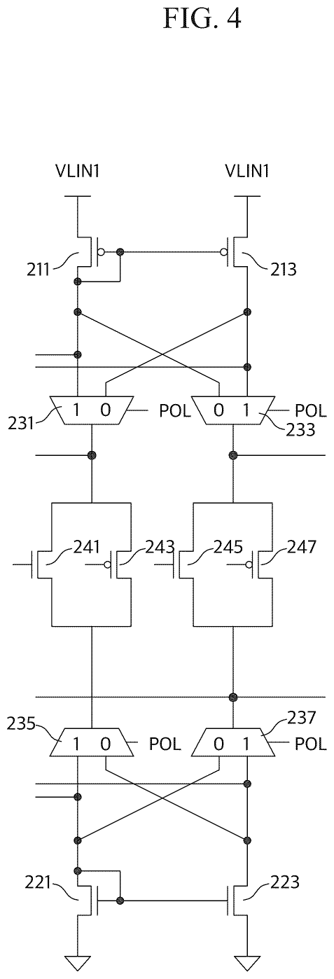

According to an example embodiment, at least one predetermined NMOS transistor may be activated among the plurality of NMOS transistors (the fourth NMOS transistor 133a, the fifth NMOS transistor 133b and the sixth NMOS transistor 133c) included in the NMOS trimming circuit 133. According to an example embodiment, all of the plurality of NMOS transistors (the fourth NMOS transistor 133a, the fifth NMOS transistor 133b and the sixth NMOS transistor 133c) included in the NMOS trimming circuit 133 may be deactivated (for example, if there is no or very small offset). At least one predetermined NMOS transistor may be determined corresponding to the size of the offset of the gamma amplifier 20, and the order of at least one predetermined NMOS transistor among multiple NMOS transistors may be stored as an NMOS trimming code. A method for searching for NMOS trimming codes will be described later. FIG. 4 is a circuit diagram of the amplification stage 200 of the offset compensating circuit 10.

Referring to FIGS. 1 to 4, the amplification stage 200 may include a plurality of PMOS transistors 211, 213, 243, and 247, a plurality of NMOS transistors 221, 223, 241 and 245, and the third MUX 230.

The NMOS transistors 221 and 223 may correspond to the first current mirror 210 of FIG. 1, and the PMOS transistors 211 and 213 may correspond to the second current mirror 220 of FIG. 1. The NMOS transistor 241, the PMOS transistor 243, the NMOS transistor 245, and the PMOS transistor 247 may correspond to the class-ab control circuit of FIG. 2. Each of a pair of the NMOS transistor 241 and the PMOS transistor 243 and a pair of the NMOS transistor 245 and PMOS transistor may operate as a floating current source.

The NMOS transistors 221 and 223, the PMOS transistors 211 and 213, the NMOS transistor 241, the PMOS transistor 243, the NMOS transistor 245, and the PMOS transistor 247 are connected between the power voltage VLIN1 and the ground voltage GND, and generate voltages corresponding to the size of the currents supplied from the input stage 100.

According to an example embodiment, the third MUX 230 may change the polarity of the offset. The third MUX 230 may operate in accordance with the second MUX 150 of the input stage 100 and thus, a detailed description will be omitted. Four MUXs may be included in the third MUX 230. The third MUX 230 may include a fifth sub MUX 231, a sixth sub MUX 233, a seventh sub MUX 235 and an eighth sub MUX 237. Based on the selection input signal POL, the third MUX 230 may output one of two signals to the class-ab control circuit.

In this regard, the third MUX 230 is a MUX for internally changing the polarity of the terminals of the gamma amplifier 20 and the third MUX 230 may change the polarity of the amplification stage of the gamma amplifier 20, and accordingly, the polarity of the offset of the gamma amplifier 20 may be changed. The driving controller may change the polarity of the input stage 100 by controlling the second MUX 150 and change the polarity of the amplification stage 200 by controlling the third MUX 230 in order to change the polarity of the offset of the gamma amplifier 20. The second MUX 150 and the third MUX 230 may be controlled by the same selection input signal POL.

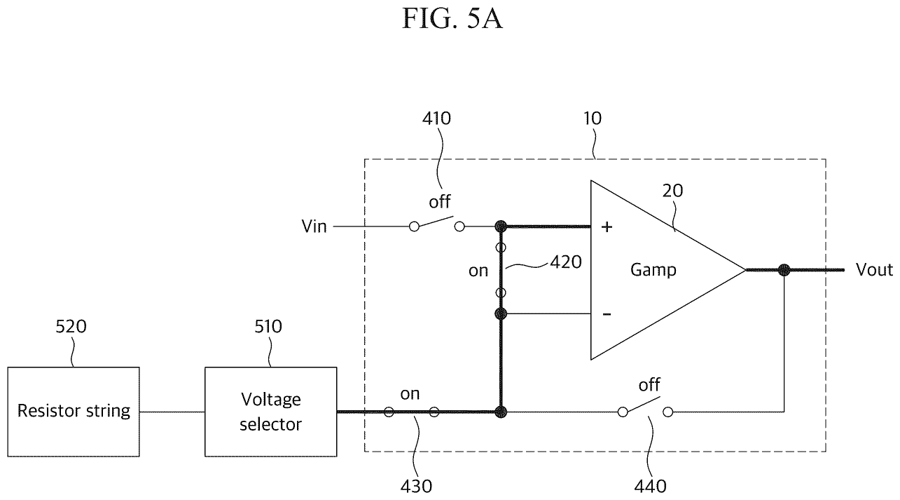

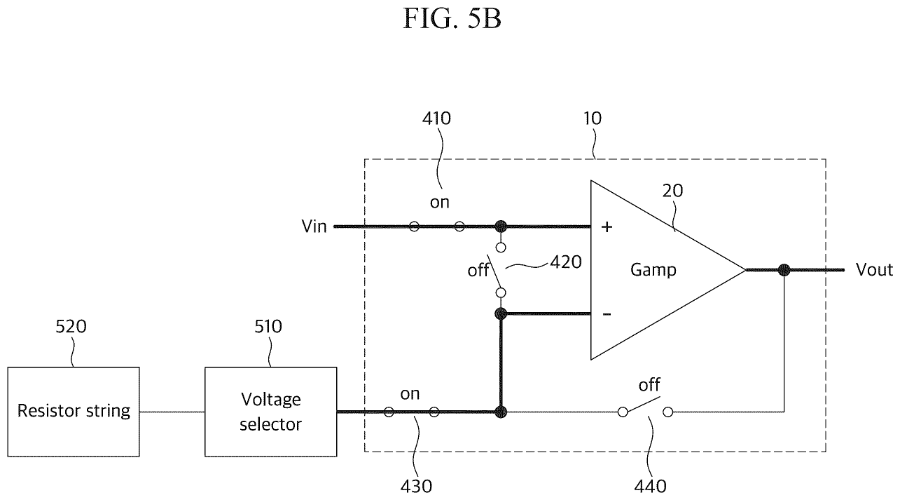

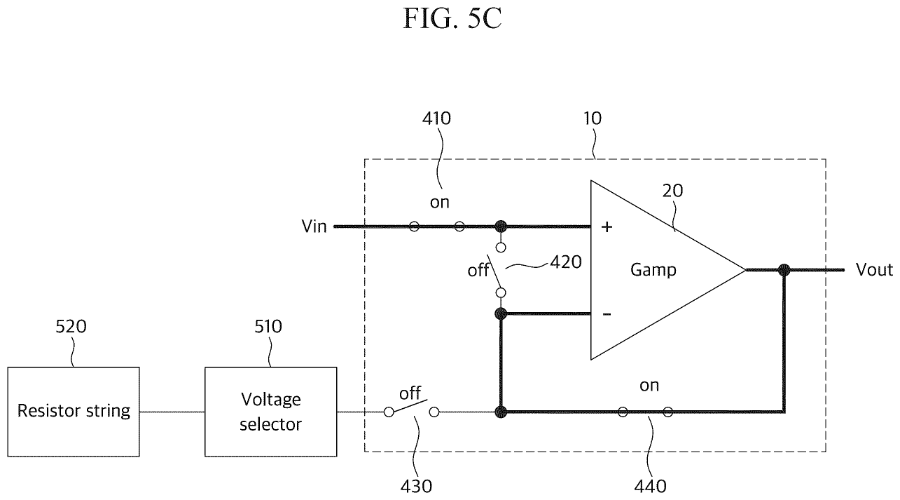

FIGS. 5A, 5B and 5C are diagrams for explaining operations of the offset compensating circuit 10 including the gamma amplifier 20 according to an example embodiment. The offset compensating circuit 10 may include a switch (for example, the switch 400 of FIG. 1) configured to control a path connected to the output stage 300 or the input stage 100 of the gamma amplifier 20. For example, the switch may include a first switch 410 located in the path between the driving controller and the input stage 100, a second switch 420 located in the path between the first input circuit 110 and the second input circuit 120 of the input stage 100, a third switch 430 located in the path between a voltage selector 510 and the input stage 100 and a fourth switch 440 located in the path between the output stage 300 and the input stage 100. The gamma amplifier 20 may have two input terminals ((+) terminal and (−) terminal). Each of the two input terminals may be connected to either the first input circuit 110 or the second input circuit 120. The voltage selector 510 is connected to a resistor string 520 to provide a reference voltage to the offset compensating circuit 10. The reference voltage supplied through the voltage selector 510 may include a first reference voltage and a second reference voltage. The reference voltage supplied through the voltage selector 510 may be determined depending on the internal input mode (the PMOS mode or the NMOS mode) of the gamma amplifier 20. The reference voltage may be used as a standard to determine the internal input mode of the gamma amplifier 20 for each frame.

Specifically, FIG. 5A illustrates a state in which the offset compensating circuit 10 operates in the first mode for sensing the offset by controlling the gamma amplifier 20 to operate as a comparator. FIG. 5B illustrates a state in which the offset compensating circuit 10 operates in a second mode to sense the voltage that is input to the gamma amplifier 20 in order to determine the internal input mode of the gamma amplifier 20. FIG. 5C illustrates a state in which the offset compensating circuit 10 operates in the third mode by controlling the gamma amplifier 20 to operate as an offset compensated buffer. The first mode, the second mode and the third mode are operation modes of the offset compensating circuit 10 determined according to the path connected to the output stage 300 or the input stage 100 by controlling the switch of the offset compensating circuit 10, and may be operating modes determined by a feedback path external to the gamma amplifier 20.

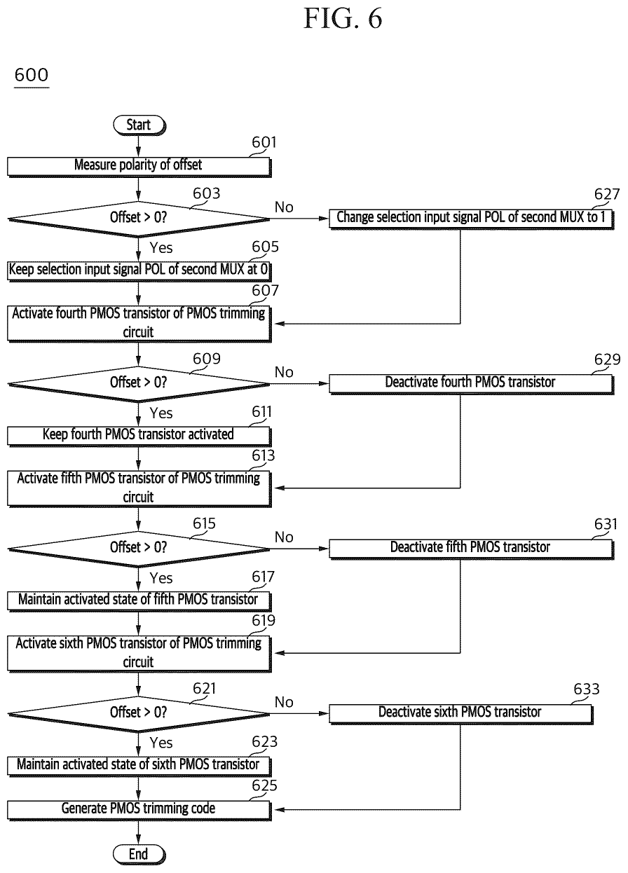

Referring to FIG. 5A, under the control of the driving controller, the first switch 410 may be opened (OFF), the second switch 420 may be shorted (ON), the third switch 430 may be shorted (ON) and the fourth switch 440 may be opened (OFF). In this case, the gamma amplifier 20 may act as a comparator. While the gamma amplifier 20 acts as a comparator, the offset compensating circuit 10 may measure the offset of the gamma amplifier 20 under the control of the driving controller and generate (i.e., identify) a trimming code to compensate for the offset. For example, if a power-up sequence for the display panel is performed or an electrical die sorting (EDS) process is performed on a semiconductor chip including the offset compensating circuit 10, as illustrated in FIG. 5A, the offset compensating circuit 10 may be operated in the first mode. While the offset compensating circuit 10 operates in the first mode, the driving controller may search for and generate a trimming code to compensate for the offset. Operation of searching for and generating a trimming code may include a PMOS trimming code generation operation performed while operating the offset compensating circuit 10 in the PMOS mode, and a NMOS trimming code generation operation performed while operating the offset compensating circuit 10 in the NMOS mode. The operation of searching for and generating a trimming code is described in example embodiments with reference to FIGS. 6, 7 and 12.

FIG. 6 is a flowchart of operations of a driving controller according to an example embodiment. Specifically, FIG. 6 is a flowchart illustrating a method of searching for and generating a PMOS trimming code for compensating the offset of the offset compensating circuit 10. In order to search for and generate a PMOS trimming code, under the control of the driving controller, the offset compensating circuit 10 may activate the PMOS trimming circuit of the first input circuit 110 and the offset trimming circuit 130, and deactivate the NMOS trimming circuit of the second input circuit 120 and the offset trimming circuit 130. In this regard, the driving controller may control the offset compensating circuit 10 to operate in the PMOS mode.

For convenience of explanation, the drawing is illustrated in the supposition that the PMOS trimming circuit of the offset trimming circuit 130 (for example, the PMOS trimming circuit 131 in FIG. 3b) includes three pairs of the PMOS transistors and the switches. In this regard, it is assumed that the offset trimming circuit 130 includes a fourth PMOS transistor (for example, the fourth PMOS transistor 131a in FIG. 3B), a fifth PMOS transistor (for example, the fifth PMOS transistor 131b in FIG. 3B), and a sixth PMOS transistor (for example, the sixth PMOS transistor 131c in FIG. 3B). Further, it is assumed that the selection input signal POL of the second MUX 150 is the default value, and the selection input signal POL is set to 0 (the logic level L) and all the PMOS transistors included in the PMOS trimming circuit are deactivated (OFF). It is assumed that if the offset is 0, it corresponds to an ideal gamma amplifier of 20, and thus the offset is 0.

Referring to an operation flowchart 600, in operation S601, the driving controller may measure the polarity of the offset voltage of the gamma amplifier 20. For example, in the state in which the offset compensating circuit 10 operates in the first mode (the state in which the gamma amplifier 20 operates as a comparator), if inputting the same (in-phase) voltage to the two input terminals of the gamma amplifier 20, the driving controller may measure the polarity of the offset voltage by measuring the polarity of the voltage that is output to the output terminal.

According to an example embodiment, in operation S603, the driving controller may identify whether the offset exceeds 0 (for example, the polarity of the offset is (+)). In order to search for a PMOS trimming code, the polarity of the offset is aligned to one. Example embodiments are described in the assumption that the polarity of the offset is aligned to (+), but the same result may be obtained even if the polarity of the offset is aligned to (−).

If the offset exceeds 0 (in this regard, the polarity of the offset is (+)), the driving controller may keep the selection input signal POL of the second MUX 150 at 0 in operation S605 (which is branched off from operation S603) (operation S603→“Yes”). In this regard, in this case, because the polarity of the offset is already aligned to (+), there is no need to change the selection input signal (i.e., 0) of the second MUX 150.

If the offset does not exceed 0 (for example, the polarity of the offset is (−)), the driving controller may change the selection input signal POL of the second MUX 150 from 0 to 1 in operation S627 (which is branched off from operation S603) (operation S603→“No”). In this case, the polarity of the offset may be changed from (−) to (+). In this regard, the driving controller may align the polarity of the offset to (+).

Hereinafter described are methods for generating a PMOS trimming code while identifying whether the polarity of the offset changes as the offset is compensated by activating a plurality of PMOS transistors included in the PMOS trimming circuit in an order of greatest set compensation voltage. Example embodiments are described in the assumption that the size of the set compensation voltage is small in the order of the fourth PMOS transistor, the fifth PMOS transistor and the sixth PMOS transistor.

In operation S607, the driving controller may activate (ON) the fourth PMOS transistor of the PMOS trimming circuit. The driving controller may control the first switch of the PMOS trimming circuit to activate the fourth PMOS transistor. In this case, the size of the offset voltage may be reduced by the compensation voltage that is set in the fourth PMOS transistor.

In operation S609, the driving controller may identify whether the offset exceeds 0 (in this regard, the polarity of the offset is (+)). In this regard, the driving controller may identify the polarity of the offset, which is reduced by the compensation voltage that is set in the fourth PMOS transistor.

If the offset exceeds 0 (i.e., the polarity of the offset is (+)), the driving controller may keep the fourth PMOS transistor activated in operation S611 (which is branched off from operation S609) (operation S609→“Yes”). In this regard, it may be identified that because the polarity of the offset did not change even after the fourth PMOS transistor is activated, the size of the offset is greater than the compensation voltage that is set for the fourth PMOS transistor. Therefore, in order to compensate for the offset, the driving controller may determine that it is appropriate to activate the fourth PMOS transistor.

If the offset does not exceed 0 (i.e., the polarity of the offset is (−)), the driving controller may then deactivate the fourth PMOS transistor again in operation S629 (which is branched off from operation S609) (operation S609→“No”). In this regard, it is identified that after the fourth PMOS transistor is activated, the polarity of the offset is changed, and thus the size of the offset is smaller than the compensation voltage that is set for the fourth PMOS transistor. Therefore, in order to compensate for the offset, the driving controller deactivate the fourth PMOS transistor.

In operation S613, the driving controller may activate (ON) the fifth PMOS transistor of the PMOS trimming circuit. The driving controller may activate the fifth PMOS transistor by controlling the second switch of the PMOS trimming circuit. In this case, the size of the offset voltage may be reduced by the compensation voltage that is set for the fifth PMOS transistor.

In operation S615, the driving controller may identify whether the offset exceeds 0 (i.e., the polarity of the offset is (+)). In this regard, the driving controller may identify the polarity of the offset, which is reduced by the compensation voltage that is set for the fifth PMOS transistor.

If the offset exceeds 0 (i.e., the polarity of the offset is (+)), the driving controller may maintain the activated state of the fifth PMOS transistor in operation S617 (which is branched off from operation S615) (operation S615→“Yes”). In this regard, it is identified that the polarity of the offset is not changed even after the fifth PMOS transistor is activated, and thus the size of the offset is larger than the compensation voltage that is set in the fifth PMOS transistor. Therefore, in order to compensate for the offset, the driving controller activates the fifth PMOS transistor.

If the offset does not exceed 0 (i.e., the polarity of the offset is (−)), the driving controller may deactivate the fifth PMOS transistor again in operation S631 (which is branched off from operation S615) (operation S615→“No”). In this regard, it is identified that the polarity of the offset is changed after the fifth PMOS transistor is activated, and thus the size of the offset is smaller than the compensation voltage that is set in the fifth PMOS transistor. Therefore, in order to compensate for the offset, the driving controller deactivates the fifth PMOS transistor.

In operation S619, the driving controller may activate the sixth PMOS transistor of the PMOS trimming circuit. The driving controller may activate the sixth PMOS transistor by controlling the third switch of the PMOS trimming circuit. In this case, the size of the offset voltage may be reduced by the compensation voltage that is set in the sixth PMOS transistor.

In operation S621, the driving controller may identify whether the offset exceeds 0 (i.e., the polarity of the offset is (+)). In this regard, the driving controller may identify the polarity of the offset, which is reduced by the compensation voltage that is set in the sixth PMOS transistor.

If the offset exceeds 0 (i.e., the polarity of the offset is (+)), the driving controller may maintain the activated state of the sixth PMOS transistor in operation S623 (which is branched off from operation S621) (operation S621→“Yes”). In this regard, it is identified that because the polarity of the offset is not changed after the sixth PMOS transistor is activated, the size of the offset is larger than the compensation voltage that is set for the sixth PMOS transistor. Therefore, in order to compensate for the offset, the driving controller activates the sixth PMOS transistor.

If the offset does not exceed 0 (i.e., the polarity of the offset is (−)), the driving controller may then deactivate the sixth PMOS transistor again in operation S633 (which is branched off from operation S621) (operation S621→“No”). In this regard, because the polarity of the offset is changed after the sixth PMOS transistor is activated, the size of the offset is smaller than the compensation voltage that is set in the sixth PMOS transistor. Therefore, in order to compensate for the offset, the driving controller deactivates the sixth PMOS transistor.

In operation S625, the driving controller may generate a PMOS trimming code. The PMOS trimming code may be a code corresponding to the result of identifying whether the polarity of the offset changes for each of the plurality of PMOS transistors included in the PMOS trimming circuit.

Below, described are specific example embodiments of searching for and generating a PMOS trimming code using the operation flowchart of FIG. 6. It is assumed that with regard to the three PMOS transistors included in the PMOS trimming circuit, the compensation voltage that is set for the fourth PMOS transistor is 4 mV, the compensation voltage that is set for the fifth PMOS transistor is 2 mV and the compensation voltage that is set for the sixth PMOS transistor is 1 mV. Further, it is assumed that the driving controller may only identify the polarity of the offset before generating a trimming code to compensate for the offset, and even though exact size of the offset cannot be determined, for convenience of explanation, the offset size is-5.5 mV.

In this case, it is identified that the driving controller has a polarity of offset (−) (see operation S601). Because the offset does not exceed 0 (because the polarity of the offset is (−)), the driving controller may change the selection input signal POL of the second MUX 150 from 0 to 1 (see operation S603 and operation S605). In this case, the polarity of the offset is changed so that the size of the offset becomes +5.5 mV. The driving controller may activate (ON) the fourth PMOS transistor (see operation S607). The compensation voltage that is set for the fourth PMOS transistor is 4 mV, and thus the offset is compensated by 4 mV, and the size of the offset becomes +1.5 mV. The driving controller may re-measure the polarity of the offset. Because the polarity of the current offset is (+), the driving controller may control the fourth PMOS transistor to remain activated (see operation S609 and operation S611). The driving controller may activate the fifth PMOS transistor (see operation S613). The compensation voltage that is set for the fifth PMOS transistor is 2 mV, and thus the size of the offset is −0.5 mV. The driving controller may re-measure the polarity of the offset. Because the polarity of the current offset is (−), the driving controller may deactivate the fifth PMOS transistor (see operation S615 and operation S631). In this case, the offset size is 1.5 mV. The driving controller may activate the sixth PMOS transistor (see operation S619). Because the compensation voltage that is set for the sixth PMOS transistor is 1 mV, the size of the offset is +0.5 mV. The driving controller may re-measure the polarity of the offset. Because the polarity of the current offset is (+), the driving controller may keep the sixth PMOS transistor activated (see operations 621 and 623). The driving controller may generate a PMOS trimming code in response to the result of identifying whether the polarity of the offset changes for each of the plurality of PMOS transistors. The PMOS trimming code may be generated in a method that when a specific PMOS transistor is activated, if the polarity of the offset does not change, 1 is set for compensation voltage, and if the polarity of the offset is changed, 0 is set for compensation voltage. In this regard, the PMOS trimming code may respond to whether the plurality of PMOS transistors are activated or not. In an example embodiment, the PMOS trimming code may be [1, 0, 1]. The PMOS trimming code may indicate that in order to compensate for the offset, in order from the first, the fourth PMOS transistor is activated, the fifth PMOS transistor is deactivated, and the sixth PMOS transistor is activated. Through this, if the offset compensating circuit 10 operates in the PMOS mode, it may be determined by at least one PMOS transistor to activate the fourth PMOS transistor and the sixth PMOS transistor among the plurality of PMOS transistors in the PMOS trimming circuit.

According to an example embodiment, if there is no offset or it is very small, all of the plurality of PMOS transistors may be deactivated. In this case, the PMOS trimming code may be [0, 0, 0].

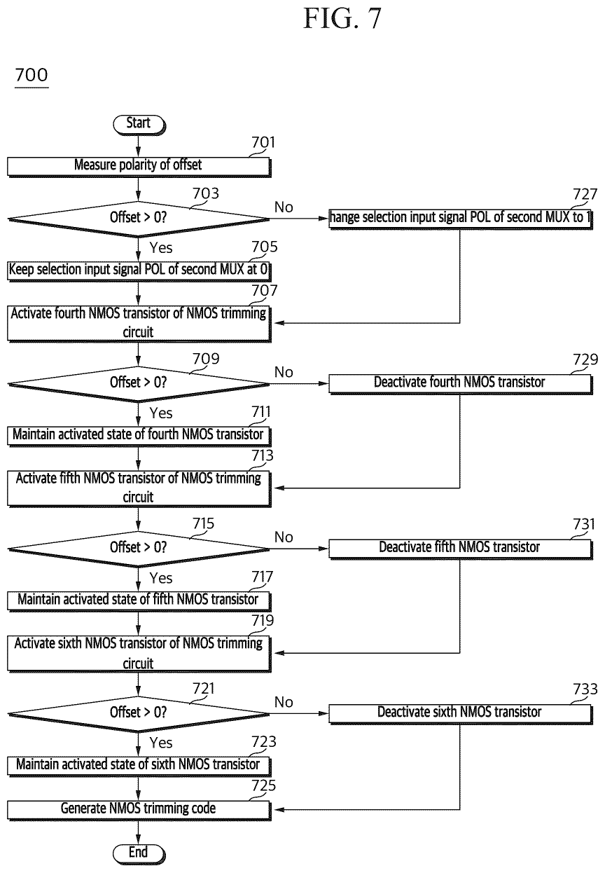

FIG. 7 is a flowchart of operations of a driving controller according to an example embodiment. Specifically, FIG. 7 is an operation flowchart illustrating a method of searching for and generating an NMOS trimming code for compensating the offset of offset compensating circuit 10. In order to search for and generate NMOS trimming codes, the offset compensating circuit 10 may deactivate the PMOS trimming circuit of the first input circuit 110 and the offset trimming circuit 130 under the control of the driving controller, and activate the NMOS trimming circuit of the second input circuit 120 and the offset trimming circuit 130. In this regard, the driving controller may control the offset compensating circuit 10 to operate in the NMOS mode. The method of searching for a NMOS trimming code is similar to the method of searching for the PMOS trimming code, and thus any descriptions that overlap the descriptions with regard to FIG. 6 will be omitted.

For convenience of explanation, in the drawing, it is assumed that the NMOS trimming circuit of the offset trimming circuit 130 (for example, the NMOS trimming circuit 133 in FIG. 3B) includes three pairs of the NMOS transistors and the switches. In this regard, it is assumed that the offset trimming circuit 130 includes a fourth NMOS transistor (for example, the fourth NMOS transistor 133a in FIG. 3B), a fifth NMOS transistor (for example, the fifth NMOS transistor 133b in FIG. 3B), and a sixth NMOS transistor (for example, the sixth NMOS transistor 133c in FIG. 3B). Further, the selection input signal POL of the second MUX 150 is the default value, and it is assumed that the selection input signal POL is set to 0 (the logic level L) and all NMOS transistors included in the NMOS trimming circuit are deactivated (OFF). If the offset is 0, the gamma amplifier 20 is ideal, and thus it is assumed that the offset is 0.

Referring to an operation flowchart 700, in operation S701, the driving controller may measure the polarity of the offset voltage of the gamma amplifier 20. In operation S703, the driving controller may identify whether the offset exceeds 0 (i.e., whether the polarity of the offset is (+)). Example embodiments with reference to the drawing is described in the assumption that the polarity of the offset is aligned to (+), but the same result may be obtained even if the polarity of the offset is aligned to (−).

If the offset exceeds 0 (i.e., the polarity of the offset is (+)), the driving controller may keep the selection input signal POL of the second MUX 150 at 0 in operation S705 (which is branched off from operation S703) (operation S703→“Yes”).

If the offset does not exceed 0 (i.e., the polarity of the offset is (−)), the driving controller may change the selection input signal POL of the second MUX 150 from 0 to 1 in operation S727 (which is branched off from operation S703) (operation S703→“No”). In this case, the polarity of the offset may be changed from (−) to (+).

Hereinafter described are methods for generating a NMOS trimming code while identifying whether the polarity of the offset changes as the offset is compensated by activating a plurality of NMOS transistors included in the NMOS trimming circuit in an order of greatest set compensation voltage. Example embodiments are described in the assumption that the size of the set compensation voltage is small in the order of the fourth NMOS transistor, the fifth NMOS transistor and the sixth NMOS transistor.

In operation S707, the driving controller may activate (ON) the fourth NMOS transistor of the NMOS trimming circuit. The driving controller may activate the fourth NMOS transistor by controlling the fourth switch of the NMOS trimming circuit. In this case, the size of the offset voltage may be reduced by the compensation voltage that is set in the fourth NMOS transistor. In operation S709, the driving controller may identify whether the offset exceeds 0 (i.e., whether the polarity of the offset is (+)).

If the offset exceeds 0 (i.e., the polarity of the offset is (+)), the driving controller may maintain the activated state of the fourth NMOS transistor in operation S711 (which is branched off from operation S709) (operation S709→“Yes”).

If the offset does not exceed 0 (i.e., the polarity of the offset is (−)), the driving controller may then deactivate the fourth NMOS transistor again in operation S729 (which is branched off from operation S709) (operation S709→“No”).

In operation S713, the driving controller may activate (ON) the fifth NMOS transistor of the NMOS trimming circuit. The driving controller may activate the fifth NMOS transistor by controlling the fifth switch of the NMOS trimming circuit. In this case, the size of the offset voltage may be reduced by the compensation voltage that is set in the fifth NMOS transistor.

In operation S715, the driving controller may identify whether the offset exceeds 0 (i.e., whether the polarity of the offset is (+)). In this regard, the driving controller may identify the polarity of the offset, which is reduced in size by the compensation voltage that is set in the fifth NMOS transistor.

If the offset exceeds 0 (i.e., the polarity of the offset is (+)), the driving controller may maintain the activated state of the fifth NMOS transistor in operation S717 (which is branched off from operation S715) (operation S715→“Yes”).

If the offset does not exceed 0 (i.e., the polarity of the offset is (−)), the driving controller may deactivate the fifth NMOS transistor again in operation S731 (which is branched off from operation S715) (operation S715→“No”).

In operation S719, the driving controller may activate the sixth NMOS transistor of the NMOS trimming circuit. The driving controller may activate the sixth NMOS transistor by controlling the third switch of the NMOS trimming circuit. In this case, the size of the offset voltage may be reduced by the compensation voltage that is set in the sixth NMOS transistor.

In operation S721, the driving controller may identify whether the offset exceeds 0 (i.e., the polarity of the offset is (+)). In this regard, the driving controller may identify the polarity of the offset, which is reduced by the compensation voltage that is set in the sixth NMOS transistor.

If the offset exceeds 0 (i.e., the polarity of the offset is (+)), the driving controller may maintain the activated state of the sixth NMOS transistor in operation S723 (which is branched off from operation S721) (operation S721→ “Yes”).

If the offset does not exceed 0 (i.e., the polarity of the offset is (−)), the driving controller may then deactivate the sixth NMOS transistor again in operation S733 (which is branched off from operation S721) (operation S721→ “No”).

In operation S725, the driving controller may generate a NMOS trimming code. The NMOS trimming code may be a code corresponding to the result of identifying whether the polarity of the offset changes for each of the multiple NMOS transistors included in the NMOS trimming circuit.

With the method, under the control of the driving controller, the offset trimming circuit 130 may activate at least one PMOS transistor corresponding to the PMOS trimming code among a plurality of PMOS transistors of the PMOS trimming circuit if the offset compensating circuit 10 operates in the PMOS mode (if the first input circuit 110 and PMOS trimming circuit are activated). According to an example embodiment, if the PMOS trimming code is [0, 0, 0], the offset trimming circuit 130 may deactivate all of the plurality of PMOS transistors under the control of the driving controller.

Under the control of the driving controller, if the offset compensating circuit 10 operates in the NMOS mode (the second input circuit 120 and the NMOS trimming circuit are activated), the offset trimming circuit 130 may activate at least one NMOS transistor corresponding to an NMOS trimming code among a plurality of NMOS transistors of the NMOS trimming circuit. According to an example embodiment, if the NMOS trimming code is [0, 0, 0], the offset trimming circuit 130 may deactivate all of the plurality of NMOS transistors under the control of the driving controller.

As illustrated in FIG. 5A, a logic of searching for the PMOS trimming code and the NMOS trimming code may be performed in the first mode for the offset compensating circuit 10 to sense the offset.

FIG. 5B is a diagram illustrating a state in which the offset compensating circuit 10 operates in a second mode to sense the voltage that is input to the gamma amplifier 20 in order to determine the internal input mode of the gamma amplifier 20.

Referring to FIG. 5B, under the control of the driving controller, the first switch 410 may be shorted (ON), the second switch 420 may be opened (OFF), the third switch 430 may be shorted (ON), and the fourth switch 440 may be opened (OFF). In this case, with respect to the gamma amplifier 20, an input voltage Vin from the driving controller may be input to the (+) terminal, and a reference voltage VR from the voltage selector 510 may be input to the (−) terminal.

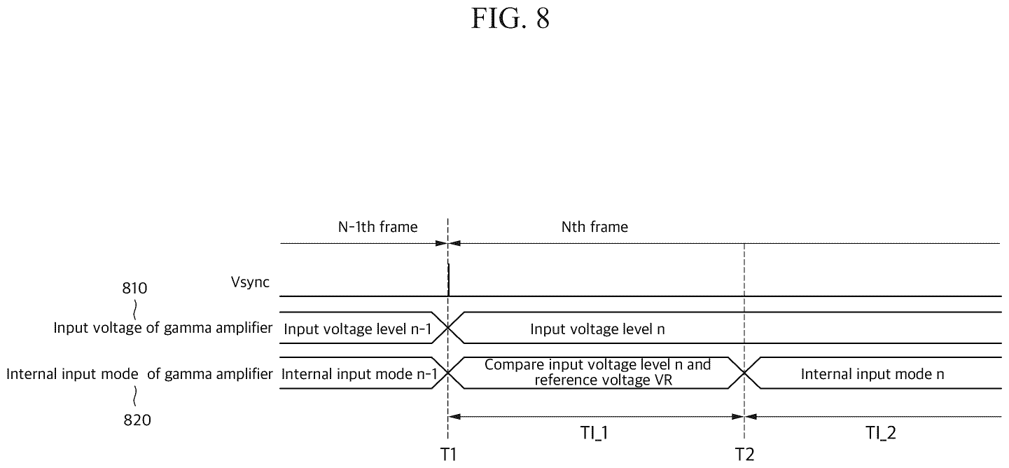

The voltage that is input to the offset compensating circuit 10 may be divided into frames. The brightness of the display panel may be adjusted by a unit of one frame, For example, the brightness of the display panel may be changed for each from. Thus, the voltage of the gamma amplifier 20 included in the offset compensating circuit 10 may also be changed by a unit of one frame. For example, the time for one frame may be 8.3 ms. Based on the input voltage Vin and the reference voltage VR of the first time period of each frame, the internal input mode (the NMOS mode or the PMOS mode) of the gamma amplifier 20 of the corresponding frame may be determined. The method of determining the internal input mode of the gamma amplifier 20 of each frame is explained with reference to FIGS. 8, 9 and 10 below.

FIG. 5C is a diagram illustrating a state in which the offset compensating circuit 10 operates in the third mode by controlling the gamma amplifier 20 to operate as an offset compensated buffer.

Referring to FIG. 5C, under the control of the driving controller, the first switch 410 is shorted (ON), the second switch 420 is opened (OFF), the third switch 430 is open (OFF), and the fourth switch 440 is shorted (ON). Therefore, the gamma amplifier 20 acts as a buffer. In the section where the display panel is activated, the offset compensating circuit 10 may operate in the third mode by applying an offset trimming code (for example, the NMOS trimming code or the PMOS trimming code) corresponding to the internal input mode (for example, the NMOS mode or the PMOS mode) of the gamma amplifier 20. In this case, the voltage with offset compensation may be output by the output stage 300 of the offset compensating circuit 10. For example, the voltage may be provided to the source driver as a gamma voltage.

FIG. 8 is a timing diagram illustrating an operation of the gamma amplifier 20 according to an example embodiment. Specifically, FIG. 8 is a timing diagram illustrating an example of the operation of the gamma amplifier 20 in an Nth frame and an N−1th frame among a plurality of frames. FIG. 8 illustrates states of a vertical synchronous signal Vsync, an input voltage 810 of the gamma amplifier 20, and an internal input mode 820 of the gamma amplifier 20.

Up to a time point T1, the time period corresponds to the N−1th frame. The driving controller may generate the vertical synchronous signal Vsync. Each frame may contain a first time period TI_1 and a second time period TI_2. The first time period TI_1 may be the period from the time point T1 to a time point T2. The second time period TI_2 may be the period from the time point T2 to the end of the Nth frame. The vertical synchronous signal Vsync may be at logic level H at the start of each frame and may be at the logic level L in the rest of the time. A section where the logic level of the vertical synchronous signal Vsync is H may be a very short section. For example, at the time point T1, if the change occurs from the N−1th frame to the Nth frame, the vertical synchronous signal Vsync may be at logic level H for a very short time. This may be referred to as a frame shot. In response to that the frame shot of the vertical synchronous signal Vsync occurs, the input voltage 810 may be input from the driving controller to the gamma amplifier 20.

The input voltage 810 is the voltage that is input from the driving controller and may be determined in response to the brightness of the display panel that is set by the user. If the brightness of the display panel is relatively bright, the input voltage 810 may be relatively low. If the brightness of the display panel is relatively dark, the input voltage 810 may be relatively high. If relatively high input voltages are used, the NMOS transistors are mainly used, and if relatively low input voltages are used, the PMOS transistors are mainly used. Therefore, it is desirable to use the internal input mode 820 of the gamma amplifier 20 that is set to either the NMOS mode or the PMOS mode depending on the size of the input voltage. As described above, the NMOS mode indicates that the first input circuit 110 and the PMOS trimming circuit of the gamma amplifier 20 are activated, and the PMOS mode indicates that the second input circuit 120 of the gamma amplifier 20 and the NMOS trimming circuit are activated.

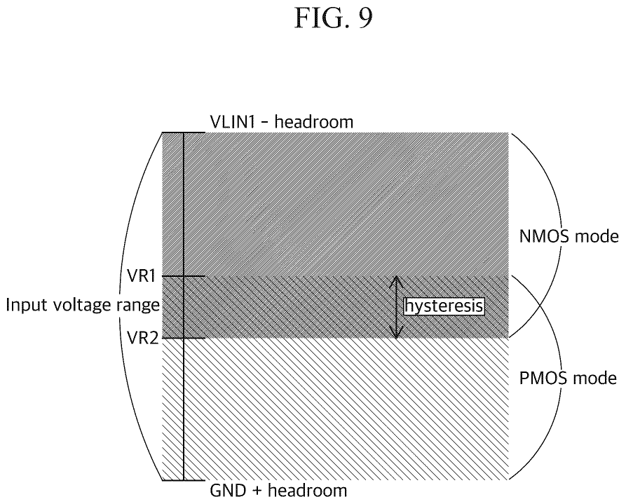

FIG. 9 is a diagram illustrating an internal input mode of the gamma amplifier 20 corresponding to a range of input voltages according to an example embodiment.

The voltage range for the gamma amplifier 20 to operate in the PMOS mode and the voltage range for operating in the NMOS mode may be set so that the ranges do not overlap each other. For example, the ground voltage GND+the headroom voltage may be 1 V, and the power voltage VLIN1−the headroom voltage may be 7 V. The available input voltage range for driving the gamma amplifier 20 in the PMOS mode may be from 1 V to 6.5 V, and the available input voltage range for driving the gamma amplifier 20 in the NMOS mode may be from 1.5 V to 7 V. In this case, for the effective offset reduction, the voltage range for the gamma amplifier 20 to operate in the PMOS mode may be set from 1 V to 4 V, and the voltage range for the gamma amplifier 20 to operate in the NMOS mode may be set to 4 V to 7 V. However, in this case, if the input voltage of the gamma amplifier 20 is 4 V, the PMOS mode and the NMOS mode may be switched for each frame due to noise, and accordingly, display flicker may occur. In order to prevent the occurrence of flicker phenomenon, the voltage range for operation in the PMOS mode and the voltage range for operation in the NMOS mode may overlap. Here, the overlapping area of the voltage may be referred to as the hysteresis area.

Referring to FIG. 9, the ground voltage GND+the headroom voltage is 1 V, and the power voltage VLIN1−the headroom voltage is 7 V. In this case, in order to effectively reduce the offset while preventing the occurrence of flicker phenomenon, the range of input voltage for the gamma amplifier 20 to operate in the PMOS mode may be set to, for example, more than 1 V and equal to or less than 4.5 V, and the range of input voltage for operation in the NMOS mode may be set to, for example, more than 3.5 V and less than or equal to 7 V. In this case, in order to operate the gamma amplifier 20 in the PMOS mode, the input voltage is equal to or less than 4.5 V. In this regard, the voltage used as a reference for the operation in the PMOS mode is referred to as a first reference voltage VR1. Similarly, to operate the gamma amplifier 20 in the NMOS mode, the input voltage must exceed 3.5 V. The voltage used as a reference for operation in the NMOS mode is referred to as a second reference voltage VR2. If the input voltage exceeds the first reference voltage, the gamma amplifier 20 may be operated in the NMOS mode. If the input voltage is less than or equal to the second reference voltage, the gamma amplifier 20 may be operated in the PMOS mode. However, if the input voltage exceeds the second reference voltage and is less than or equal to the first reference voltage, the gamma amplifier 20 may be operated in an internal input mode between the PMOS mode and the NMOS mode. The range that exceeds the second reference voltage and is equal to or lower than the first reference voltage may be referred to as the hysteresis area. If the input voltage exceeds the second reference voltage and is less than or equal to the first reference voltage, there is a need to quickly determine which internal input mode the gamma amplifier 20 to be operated in.

Referring back to FIG. 8, by comparing an input voltage level n and the reference voltage during the first time period TI_1 of the Nth frame, the driving controller may determine the internal input mode 820 of the gamma amplifier 20 during the second time period TI_2 of the Nth frame. The reference voltage may be either the first reference voltage VR1 or the second reference voltage VR2. If the internal input mode 820 of the gamma amplifier 20 in the N−1th frame is the PMOS mode, the driving controller may determine the reference voltage in the Nth frame as the first reference voltage VR1. If the internal input mode 820 of the gamma amplifier 20 in the N−1th frame is the NMOS mode, the driving controller may determine the reference voltage in the Nth frame as the second reference voltage VR2.

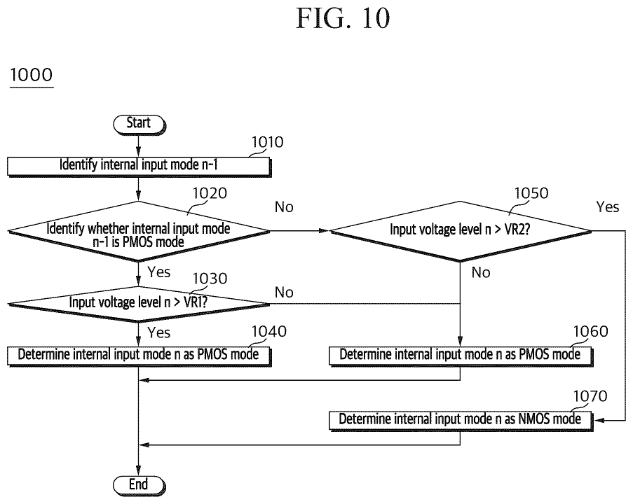

FIG. 10 is a flowchart of operations of a driving controller according to an example embodiment. Specifically, FIG. 10 is a flowchart of operations to determine the internal input mode of the gamma amplifier 20 for each frame.

Referring to an operation flowchart 1000, in operation S1010, the driving controller may identify the internal input mode of the gamma amplifier 20 in the n−1th frame (i.e., an internal input mode n−1).

In operation S1020, if the internal input mode n−1 of the gamma amplifier 20 is the PMOS mode, the driving controller may identify whether the input voltage level of the Nth frame (i.e., the input voltage level n) exceeds the first reference voltage VR1 in operation $1030 (which is branched off from operation $1020) (operation S1020→“Yes”).

If the input voltage level n exceeds the first reference voltage, the driving controller may determine the internal input mode (i.e., the internal input mode n) of the gamma amplifier 20 as the NMOS mode in the Nth frame in operation S1040 (which is branched off from operation S1030) (operation S1030→“Yes”).

If the input voltage level n does not exceed the first reference voltage, the driving controller may determine the internal input mode n as the PMOS mode in operation S1060 (which is branched off from operation S1030) (operation S1030→“No”).

With respect to operation S1020, if the internal input mode n−1 of the gamma amplifier 20 is the NMOS mode, the driving controller may identify whether the input voltage level n exceeds the second reference voltage VR2 in operation S1050 (which is branched off from operation S1020) (operation S1020→“No”).

If the input voltage level n exceeds the second reference voltage VR2, the driving controller may determine the internal input mode (i.e., the internal input mode n) of the gamma amplifier 20 as the NMOS mode in the Nth frame in operation S1070 (which is branched off from operation S1050) (operation S1050→“Yes”).

If the input voltage level n does not exceed the second reference voltage VR2, the driving controller may determine the internal input mode (i.e., the internal input mode n) of the gamma amplifier 20 as the PMOS mode in the Nth frame in operation S1060 (which is branched off from operation S1050) (operation S1050→“No”).

Referring to FIG. 10, the input voltage level is 6 V in the N−1th frame, and the internal input mode of the gamma amplifier 20 is the NMOS mode. Further, the first reference voltage is 4.5 V, and the second reference voltage is 3.5 V. In this case, because the internal input mode of the gamma amplifier 20 in the N−1th frame is the NMOS mode, the reference voltage that determines the internal input mode of the Nth frame may be determined by the second reference voltage. If the input voltage level is 3.8 V in the Nth frame, the second reference voltage is exceeded, and thus the driving controller may determine the internal input mode of the gamma amplifier 20 as the NMOS mode in the Nth frame. If the input voltage level is 3.2 V in the Nth frame, the input voltage level does not exceed the second reference voltage, and thus the driving controller may determine the internal input mode of the gamma amplifier 20 as the PMOS mode in the Nth frame.

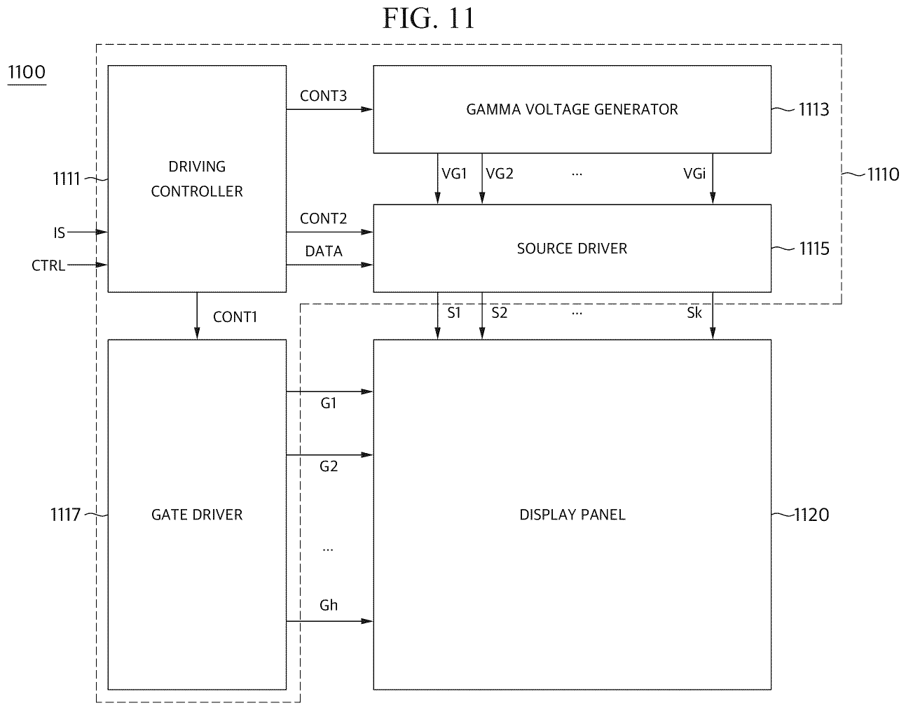

FIG. 11 is a block diagram illustrating a display apparatus 1100 according to an example embodiment.

Referring to FIG. 11, the display apparatus 1100 may include a display driving circuit 1110 and a display panel 1120. The display driving circuit 1110 may include a driving controller 1111, a gamma voltage generator (i.e., gamma voltage generation circuit) 1113, a source driver 1115 and a gate driver 1117.

According to an example embodiment, the display panel 1120 may include a plurality of pixels for displaying images. A pixel may be connected to a corresponding source line among a plurality of source lines and a corresponding gate line among a plurality of gate lines. The pixel may receive a data signal from the source line if a gate signal is supplied to the gate line. The pixel may express light of a certain brightness corresponding to an input data signal. A plurality of pixels may display an image in a unit of one frame. A pixel may be implemented as an R sub-pixel, a G sub-pixel and a B sub-pixel.

Some or all of the gate driver 1117, the source driver 1115, the gamma voltage generator 1113, and the driving controller 1111 may be implemented in the same semiconductor die, chip, or module or may be implemented as separate semiconductor dies, chips, or modules. In an example embodiment, the gate driver 1117 and/or the source driver 1115 may be implemented on the same substrate as the display panel 1120. In this case, the gate driver 1117 and/or the source driver 1115 may be placed on the periphery of the display panel 1120.

According to an example embodiment, the gate driver 1117 may provide a plurality of gate signals G1, G2, . . . , and Gh to the display panel 1120 according to a gate driver control signal CONT1. The plurality of gate signals G1, G2, . . . , and Gh may be pulse signals having an enable level and a disable level. The plurality of gate signals G1, G2, . . . , and Gh may be applied to a plurality of gate lines. If a gate signal of an enable level is applied to the gate line connected to the pixel, a data signal applied to a source line connected to a pixel may be transmitted to the pixel.

According to an example embodiment, the source driver 1115 may receive data (DATA in FIG. 11) in the form of a digital signal from the driving controller 1111 and convert the data (DATA in FIG. 11) into data signals S1, S2, . . . , and Sk in the form of analog signals. Here, the data (DATA in FIG. 11) may include grayscale information corresponding to each pixel for displaying image data IS on the display panel 1120. The source driver 1115 may transmit the plurality of data signals S1, S2, . . . , and Sk to the display panel 1120 according to a source driver control signal CONT2 provided from the driving controller 1111. The source driver 1115 may be referred to as a data driver. In this regard, the source driver 1115 may receive the gamma voltage that is output from the gamma voltage generator 1113 and output a data signal.

The gamma voltage generator 1113 may generate a plurality of gamma voltages VG1, VG2, . . . , and VGi and provide the gamma voltages to the source driver 1115. The plurality of gamma voltages VG1, VG2, . . . , and VGi may have i number of different voltage levels. The plurality of gamma voltages VG1, VG2, . . . , and VGi may be used by the source driver 1115 to generate an analog signal corresponding to the data (DATA in FIG. 11). The gamma voltage generator 1113 may be referred to as a gamma voltage generation circuit.

The gamma voltage generator 1113 (or a gamma voltage generation circuit) may be configured to receive an input voltage that is output from the driving controller 1111 and output a gamma voltage. The gamma voltage generator 1113 may include an offset compensating circuit of FIG. 1. In this regard, the gamma voltage generator 1113 may generate the plurality of offset-compensated gamma voltages VG1, VG2, . . . , and VGi and provide the plurality of offset-compensated gamma voltages to the source driver 1115.

According to an example embodiment, the driving controller 1111 may receive the image data IS and a drive control signal CTRL from the host device, and control the gate driver 1117, the source driver 1115 and the gamma voltage generator 1113. Here, the host device may refer to a computing device that controls the display apparatus to display an image desired by a user on the display panel 1120 from the outside. The driving controller 1111 may control the gamma voltage generator 1113 by sending the vertical synchronous signal Vsync and a gamma voltage generation signal to the gamma voltage generator 1113.

The driving controller 1111 may generate the data (DATA in FIG. 11) by dividing the video data IS into frames based on the vertical synchronous signal Vsync, and dividing the video data IS into gate lines based on a horizontal synchronous signal Hsync. The driving controller 1111 may control operations to synchronize the source driver 1115 and the gate driver 1117 by transmitting the gate driver control signal CONT1 and the source driver control signal CONT2 to the gate driver 1117 and the source driver 1115. The driving controller 1111 may control the operation of the gamma voltage generator 1113 by sending a gamma voltage generation control signal CONT3 to the gamma voltage generator 1113. Independent of the drive control signal CTRL received from the host device, or in addition to the drive control signal CTRL, the driving controller 1111 may control the gate driver 1117, the source driver 1115, and the gamma voltage generator 1113 based on the control commands generated by the driving controller 1111 itself.

The driving controller 1111 may transmit various control signals to control the offset compensating circuit 10 of the gamma voltage generator 1113. For example, the driving controller 1111 may transmit the selection input signals (for example, the selection input signal VBP_SEL, the selection input signal VBN_SEL and the selection input signal POL) for controlling each of the first MUX 140 and the second MUX 150 of the offset compensating circuit 10, and the third MUX 230. For example, the driving controller 1111 may transmit switch control signals to activate the PMOS transistors and the NMOS transistors of the offset trimming circuit 130 that correspond to the PMOS trimming code and the NMOS trimming code.

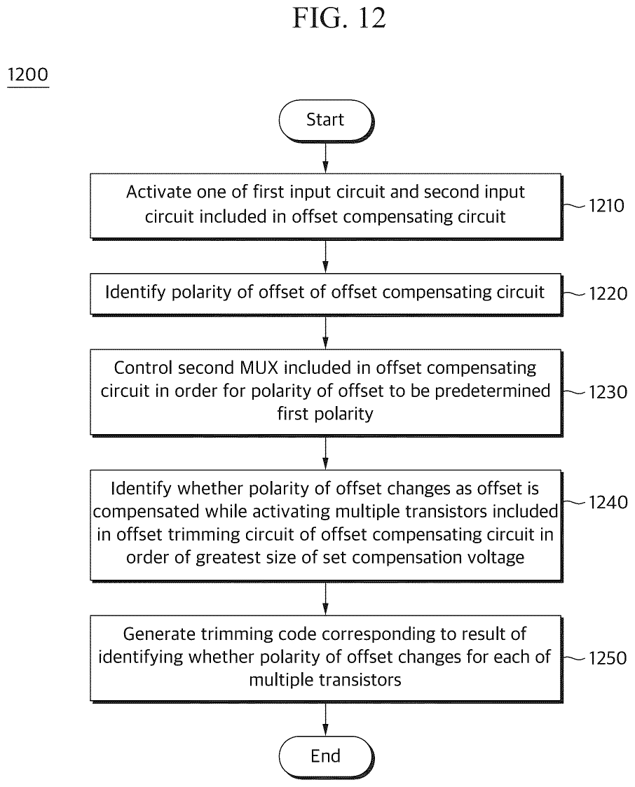

FIG. 12 is a flowchart of operations of the display driving circuit 1110 according to an example embodiment. The display driving circuit 1110 may include the driving controller 1111, the gamma voltage generation circuit 1113 and the source driver 1115. The gamma voltage generation circuit 1113 may include the offset compensating circuit 10. FIG. 12 is a flowchart of operations of a method for generating a trimming code of the offset compensating circuit 10 included in the gamma voltage generation circuit 1113 by the driving controller 1111 of the display driving circuit 1110.

Referring to an operation flowchart 1200, in operation S1210, the driving controller 1111 of the display driving circuit 1110 controls the first MUX 140 of the offset compensating circuit 10 to activate one of the first input circuit 110 and the second input circuit 120 included in the offset compensating circuit 10. The first MUX 140 of the offset compensating circuit 10 may be controlled to activate one of the first input circuit 110 and the second input circuit 120 included in the offset compensating circuit 10. Based on the input voltage and reference voltage during the first time period of each frame, the driving controller 1111 may determine the internal input mode of the offset compensating circuit 10 in a corresponding frame. In response to the internal input mode of the above-determined offset compensating circuit 10, the driving controller 1111 may activate the first input circuit 110 and the second input circuit 120. For example, if the internal input mode of the offset compensating circuit 10 is determined as the PMOS mode, the driving controller 1111 may activate the first input circuit 110. For example, if the internal input mode of the offset compensating circuit 10 is determined as the NMOS mode, the driving controller 1111 may activate the second input circuit 120.

In operation S1220, the driving controller 1111 may identify the polarity of the offset of the offset compensating circuit 10. While the offset compensating circuit 10 operates in the first mode for sensing the offset, the driving controller 1111 may identify the polarity of the offset of the offset compensating circuit 10. The driving controller 1111 may identify whether the polarity of the offset of the offset compensating circuit 10 is (+) or (−).

In operation S1230, the driving controller 1111 may control the second MUX 150 included in the offset compensating circuit 10 so that the polarity of the offset becomes a predetermined first polarity. For example, if the predetermined first polarity is (+) and the polarity of the offset identified in operation S1220 is (−), the driving controller 1111 may change the polarity of the offset to (+) by changing the selection input signal POL that is input to the second MUX 150.

In operation S1240, the driving controller 1111 may identify whether the polarity of the offset changes as offset is compensated while activating multiple transistors included in the offset trimming circuit 130 of the offset compensating circuit 10 in the order of the greatest size of the set compensation voltage. If the first input circuit 110 of the offset compensating circuit 10 is activated, the PMOS trimming circuit 131 of the offset trimming circuit 130 is activated. If the second input circuit 120 of the offset compensating circuit 10 is activated, the NMOS trimming circuit 133 of the offset trimming circuit 130 is activated. For example, if the PMOS trimming circuit 131 is activated, the driving controller 1111 may identify whether the polarity of the offset changes as the offset is compensated while a plurality of PMOS transistors included in the PMOS trimming circuit 131 are activated in the order of the greatest size of the set compensation voltage. For example, if the NMOS trimming circuit 133 is activated, the driving controller 1111 may identify whether the polarity of the offset changes as the offset is compensated while the plurality of PMOS transistors included in the PMOS trimming circuit 131 are activated in the order of the greatest size of the set compensation voltage.

In operation S1250, the driving controller 1111 may generate a trimming code corresponding to the result of identifying whether the polarity of the offset changes for each of the multiple transistors. For example, if the PMOS trimming circuit 131 is activated, the driving controller 1111 may generate the PMOS trimming code corresponding to the result of identifying whether the polarity of the offset changes for each of the plurality of PMOS transistors included in the PMOS trimming circuit 131. The PMOS trimming code may respond to whether the plurality of PMOS transistors are activated or not. For example, if the NMOS trimming circuit 133 is activated, the driving controller 1111 may generate the NMOS trimming code corresponding to the result of identifying whether the polarity of the offset changes for each of a plurality of NMOS transistors included in the NMOS trimming circuit 133. The NMOS trimming code may respond to the activation or deactivation of the plurality of NMOS transistors.

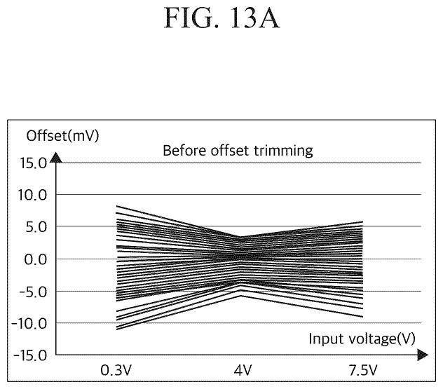

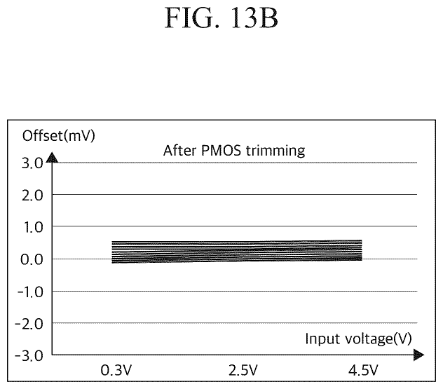

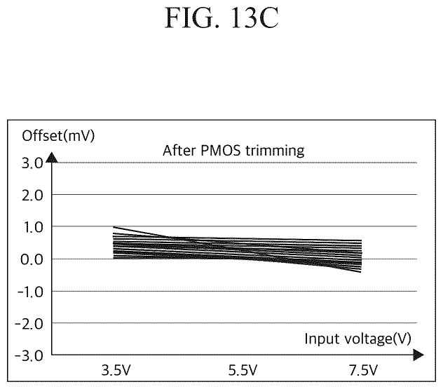

FIGS. 13A, 13B and 13C are graphs showing the size of an offset according to an input voltage if using an offset compensating circuit according to an example embodiment. Specifically, FIGS. 13A, 13B and 13C are graphs showing the results of a Monte Carlo simulation using an offset compensating circuit according to an example embodiment. FIG. 13A is data showing the size of the offset according to the input voltage before offset trimming. FIG. 13B is data showing the size of the offset according to the input voltage after PMOS trimming. FIG. 13C is data showing the size of the offset according to the input voltage after performing NMOS trimming.

Referring to FIGS. 13A, 13B and 13C, typically, customers who want to purchase the gamma amplifier 20 wish the gamma amplifier 20 with an offset size of a certain threshold or below. It is identified that before offset trimming, in a range where the input voltage is relatively low, the offset ranges from approximately −12 m V to +9 mV. It is identified that if the offset compensating circuit 10 operates in the PMOS mode and the PMOS trimming is performed by applying the PMOS trimming code, the offset size is approximately-0.3 mV to +0.7 mV, and this satisfies the specification requirements of the customer. If the offset compensating circuit 10 operates in the NMOS mode and the NMOS trimming is performed by applying the NMOS trimming code, offset size is approximately −0.5 mV to +1.0 mV, and this satisfies the specification requirements of the customer. Therefore, if an offset compensating circuit according to various example embodiments of the present disclosure is used, current consumption may be significantly reduced and the used area may be significantly reduced if compared to the offset compensating circuit using the existing Dual auto-zero method, though offset compensation performance is similar.

The electronic device according to the above-described example embodiments may include a processor, a memory for storing and executing program data, a permanent storage such as a disk drive, and/or a user interface device such as a communication port, a touch panel, a key and/or a button that communicates with an external device. Methods implemented as software modules or algorithms may be stored in a computer-readable recording medium as computer-readable codes or program instructions executable on the processor. Here, the computer-readable recording medium includes a magnetic storage medium (for example, ROMs, RAMs, floppy disks, and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

While aspects of example embodiments have been particularly shown and described, it will be understood that various changes in form and details may be made therein without departing from the spirit and scope of the following claims.

What is claimed is:

1. An offset compensating circuit comprising:
an input stage circuit comprising a first input circuit, a second input circuit, a first multiplexer configured to activate one of the first input circuit and the second input circuit, a second multiplexer configured to change a polarity of an offset of a gamma voltage generation circuit, and an offset trimming circuit configured to compensate the offset;
an amplification stage circuit comprising a first current mirror, a second current mirror and a third multiplexer configured to change the polarity of the offset;
an output stage circuit configured to receive voltages generated from the first current mirror and the second current mirror; and
a switch configured to control a path connected to the output stage circuit or the input stage circuit.

2. The offset compensating circuit of claim 1, wherein the offset trimming circuit comprises:
a p-channel metal-oxide semiconductor (PMOS) trimming circuit comprising a plurality of pairs of PMOS transistors and switches configured to individually control whether the PMOS transistors are activated; and
an n-channel metal-oxide semiconductor (NMOS) trimming circuit comprising a plurality of pairs of NMOS transistors and switches configured to individually control whether the NMOS transistors are activated,
wherein the plurality of PMOS transistors included in the PMOS trimming circuit have different compensation voltages, and
wherein the plurality of NMOS transistors included in the NMOS trimming circuit have different compensation voltages.

3. The offset compensating circuit of claim 2, wherein the first multiplexer is configured to activate one of the PMOS trimming circuit and the NMOS trimming circuit.

4. The offset compensating circuit of claim 3, wherein the offset trimming circuit is configured to:
based on the first input circuit and the PMOS trimming circuit being activated, activate at least one predetermined PMOS transistor among the plurality of PMOS transistors; and
based on the second input circuit and the NMOS trimming circuit being activated, activate at least one predetermined NMOS transistor among the plurality of NMOS transistors.

5. The offset compensating circuit of claim 4, wherein the at least one predetermined PMOS transistor is determined by a driving controller identifying whether the polarity of the offset is changed as the offset is compensated while activating the plurality of PMOS transistors in an order of greatest compensation voltage, in a state that the first input circuit and the PMOS trimming circuit are activated.

6. The offset compensating circuit of claim 4, wherein the at least one predetermined NMOS transistor is determined by a driving controller identifying whether the polarity of the offset is changed as the offset is compensated while activating the plurality of NMOS transistors in an order of greatest compensation voltage, in a state that the second input circuit and the NMOS trimming circuit are activated.

7. The offset compensating circuit of claim 1, wherein the offset compensating circuit is a complementary metal-oxide-semiconductor (CMOS) circuit,
wherein the first input circuit comprises a plurality of PMOS transistors, and
wherein the second input circuit comprises a plurality of NMOS transistors.

8. The offset compensating circuit of claim 7, wherein the first multiplexer comprises a first sub multiplexer and a second sub multiplexer,
wherein the first sub multiplexer is connected to a gate terminal of a first PMOS transistor among the plurality of PMOS transistors that is connected to a power voltage,
wherein the second sub multiplexer is connected to a gate terminal of a first NMOS transistor among the plurality of NMOS transistors that is connected to a ground voltage,
wherein the first sub multiplexer is configured to control whether to supply a PMOS bias voltage or the power voltage to the gate terminal of the first PMOS transistor,
wherein the second sub multiplexer is configured to control whether to supply a NMOS bias voltage or the ground voltage to the gate terminal of the first NMOS transistor,
wherein the plurality of PMOS transistors are activated based on the first PMOS transistor being activated, and
wherein the plurality of NMOS transistors are activated based on the first NMOS transistor being activated.

9. The offset compensating circuit of claim 8, wherein the plurality of PMOS transistors comprises the first PMOS transistor and remaining PMOS transistors,
wherein the plurality of NMOS transistors comprises the first NMOS transistor and remaining NMOS transistors,
wherein a plurality of second multiplexers are connected to gate terminals of the remaining PMOS transistors and gate terminals of the remaining NMOS transistors.

10. The offset compensating circuit of claim 1, wherein the offset compensating circuit is configured to receive an input voltage that is divided into frames,
wherein the switch is configured to:
control the path in order for the first input circuit and the second input circuit of the input stage circuit and the output stage circuit not to be connected to each other in a first time period of each of the frames; and
control the path in order for the second input circuit of the input stage circuit and the output stage circuit to be connected to each other in a second time period of each of the frames.

11. The offset compensating circuit of claim 10, wherein the first multiplexer is configured to activate one of the first input circuit and the second input circuit for each of a plurality of frames.

12. A display driving circuit comprising:
a driving controller;
a gamma voltage generation circuit that is configured to receive an input voltage that is output from the driving controller and output a gamma voltage, wherein the gamma voltage generation circuit comprises an offset compensating circuit;
a source driver configured to receive the gamma voltage and output a data signal; and
a gate driver configured to output a gate signal,
wherein the offset compensating circuit comprises:
an input stage circuit comprising a first input circuit, a second input circuit, a first multiplexer configured to activate one of the first input circuit and the second input circuit, a second multiplexer configured to change a polarity of an offset of the gamma voltage generation circuit, and an offset trimming circuit configured to compensate the offset;
an amplification stage circuit comprising a first current mirror, a second current mirror and a third multiplexer configured to change the polarity of the offset;
an output stage circuit configured to receive voltages generated from the first current mirror and the second current mirror; and
a switch configured to control a path connected to the output stage circuit or the input stage circuit.

13. The display driving circuit of claim 12, wherein the offset trimming circuit comprises:
a p-channel metal-oxide semiconductor (PMOS) trimming circuit comprising a plurality of pairs of PMOS transistors and switches configured to individually control whether the PMOS transistors are activated; and
an n-channel metal-oxide semiconductor (NMOS) trimming circuit comprising a plurality of pairs of NMOS transistors and switches configured to individually control whether the NMOS transistors are activated,
wherein the plurality of PMOS transistors included in the PMOS trimming circuit have different compensation voltages, and
wherein the plurality of NMOS transistors included in the NMOS trimming circuit have different compensation voltages.

14. The display driving circuit of claim 13, wherein the driving controller is configured to:
control the first multiplexer and the offset trimming circuit to activate the first input circuit and the PMOS trimming circuit;
identify the polarity of the offset of the gamma voltage generation circuit;
control the second multiplexer to control the polarity of the offset to be a predetermined first polarity;
identify whether the polarity of the offset changes as the offset is compensated while the plurality of PMOS transistors are activated in an order of greatest compensation voltage; and
generate a PMOS trimming code corresponding to a result of identifying whether the polarity of the offset changes for each of the plurality of PMOS transistors.

15. The display driving circuit of claim 13, wherein the driving controller is configured to:
control the first multiplexer and the offset trimming circuit to activate the second input circuit and the NMOS trimming circuit;
identify the polarity of the offset of the gamma voltage generation circuit;
control the second multiplexer to control the polarity of the offset to be a predetermined first polarity;
identify whether the polarity of the offset changes as the offset is compensated while the plurality of NMOS transistors are activated in an order of greatest compensation voltage; and
generate a NMOS trimming code corresponding to a result of identifying whether the polarity of the offset changes for each of the plurality of NMOS transistors.

16. The display driving circuit of claim 12, wherein the input voltage is divided into frames, and
wherein the driving controller is configured to:
through the switch, control the path in order for the first input circuit and the second input circuit of the input stage circuit and the output stage circuit not to be connected to each other in a first time period of each of the frames; and
through the switch, control the path in order for the second input circuit of the input stage circuit and the output stage circuit to be connected to each other in a second time period of each of the frames.

17. The display driving circuit of claim 16, wherein the driving controller is configured to:
determine a reference voltage as a first voltage based on the first input circuit being activated in a first frame;
compare the first voltage and the input voltage that is input to the offset compensating circuit in the first time period of a second frame that is a next frame of the first frame; and
based on a result of comparison between the input voltage and the first voltage, determine a single input circuit to be activated in the second time period of the second frame between the first input circuit and the second input circuit.

18. The display driving circuit of claim 12, wherein the offset compensating circuit is implemented with a complementary metal-oxide-semiconductor (CMOS) circuit, wherein the first input circuit comprises a plurality of PMOS transistors, and wherein the second input circuit comprises a plurality of NMOS transistors.

19. The display driving circuit of claim 17, wherein the driving controller is configured to:
determine the reference voltage as a second voltage based on the second input circuit being activated in the second frame;
compare the second voltage and the input voltage that is input to the offset compensating circuit in the first time period of a third frame that is a next frame of the second frame; and
based on a result of comparison between the input voltage and the second voltage, determine a single input circuit to be activated in the second time period of the third frame between the first input circuit and the second input circuit.

20. A method of operating a display driving circuit including a driving controller, a gamma voltage generation circuit including an offset compensating circuit, a source driver and a gate driver, the method comprising:
activating one of a first input circuit and a second input circuit included in the offset compensating circuit by controlling a first multiplexer included in the offset compensating circuit;
identifying a polarity of an offset of the offset compensating circuit;
controlling a second multiplexer and a third multiplexer included in the offset compensating circuit to control the polarity of the offset to be a predetermined first polarity;
identifying whether the polarity of the offset changes as the offset is compensated while a plurality of transistors included in an offset trimming circuit of the offset compensating circuit are activated in an order of greatest compensation voltage; and
generating a trimming code corresponding to a result of identifying whether the polarity of the offset changes for each of the plurality of transistors.
